(19) United States
(12) Patent Application Publication
(10) Pub. No.: US 2025/0171175 A1
(43) Pub. Date: May 29, 2025

(54) AUTOMATED SYSTEMS AND METHODS FOR FOIL PACKAGING COMPONENTS

(71) Applicant: AMGEN INC., Thousand Oaks, CA (US)

(72) Inventor: Jan Mikael Jensen, Herlev (DK)

(73) Assignee: AMGEN INC., Thousand Oaks, CA (US)

(21) Appl. No.: 18/962,768

(22) Filed: Nov. 27, 2024

Related U.S. Application Data
(60) Provisional application No. 63/603,139, filed on Nov. 28, 2023.

(51) Int. Cl. B65B 11/50; B65B 41/10; B65B 51/14; B65B 57/16

(52) U.S. Cl. CPC B65B 11/50; B65B 41/10; B65B 51/14; B65B 57/16

(57) ABSTRACT

Systems and methods of foil packaging components of a drug delivery device comprise introducing a first sheet of foil and a second sheet of foil into a welding assembly, welding the first sheet of foil and the second sheet of foil together at a first subsection of the first and second sheets of foil to define a first welded subsection, providing a component for a drug delivery device between the first sheet of foil and the second sheet of foil above the first welded subsection, unclamping the first welding bar and the second welding bar from the first welded subsection, moving the first sheet of foil and the second sheet of foil downward in the welding assembly, and welding the first sheet of foil and the second sheet of foil together at a second subsection of the first and second sheets of foil to define a second welded subsection.

### CROSS-REFERENCE TO RELATED APPLICATIONS

Priority is claimed to U.S. Provisional Patent Application No. 63/603,139, filed Nov. 28, 2023, the entire contents of which are hereby incorporated by reference herein.

### FIELD OF DISCLOSURE

The present disclosure generally relates to automated systems and methods for packaging components and, more particularly, to automated systems and methods for packaging components for drug delivery devices in foil. The present disclosure also generally relates to automated systems and methods for unloading the components for drug delivery devices from the foil packaging.

### BACKGROUND

Drug delivery devices such as autoinjectors use various types of springs as drive mechanisms. Generally, a spring is initially in an energized state and, when activated, the energy stored in the spring is transferred to a plunger of the drug delivery device to drive the plunger and expel a drug. During development of these drug delivery devices, each individual component of a drug delivery device needs to be inspected and packaged so that each component can be shipped from a manufacturing site to an assembly site for final assembly of the drug delivery device.

The packaging used for transporting these drug delivery device components not only needs to be able to protect the components during delivery, but it would also be desirable for the packaging to be sustainable, cost-effective, and efficient, particularly for mass production of drug delivery devices. Various types of packaging can be used to transport components for a drug delivery device, including plastic trays, plastic cartons, cardboard boxes, or the like. However, such packaging may require packers at a manufacturing site to manually pack individual components onto a tray, into a box, and further into a pallet before they are transported to an assembly site. Moreover, at the assembly site, each individual component may need to be manually unloaded from its packaging, and all packaging (e.g., trays and boxes) may need to be discarded.

Accordingly, there is a need for systems and methods for packaging and unloading components for a drug delivery device that improve sustainability, production costs, and efficiency. The present disclosure sets forth systems and methods to address one or more of the needs and challenges mentioned herein and other related needs and challenges.

### SUMMARY

In accordance with one embodiment of the present disclosure, a method of foil packaging components for a drug delivery device comprises introducing a first sheet of foil and a second sheet of foil into a welding assembly. The welding assembly may include a first welding bar and a second welding bar. The method comprises welding the first sheet of foil and the second sheet of foil together at a first subsection of the first and second sheets of foil to define a first welded subsection. Welding the first and second sheets of foil together at the first subsection includes clamping the first welding bar and the second welding bar at the first subsection. The method further comprises providing a component for a drug delivery device between the first sheet of foil and the second sheet of foil above the first welded subsection, unclamping the first welding bar and the second welding bar from the first welded subsection, moving the first sheet of foil and the second sheet of foil downward in the welding assembly, and welding the first sheet of foil and the second sheet of foil together at a second subsection of the first and second sheets of foil to define a second welded subsection. The second welded subsection may be offset a predefined distance from the first welded subsection. After welding the first and second sheets of foil together at the first and second subsections, the first welded subsection may be on one side of the component, and the second welded subsection may be on an opposite side of the component such that the component is surrounded by the first and second sheets of foil.

In some embodiments, the method may further comprise repeating the steps of providing the component for the drug delivery device between the first sheet of foil and the second sheet of foil, unclamping the first and second welding bars, moving the first and second sheets of foil downward in the welding assembly, and welding the first and second sheets of foil together until each of the components for the drug delivery device is individually packaged in foil. In some embodiments, introducing the first sheet of foil and the second sheet of foil into the welding assembly may comprise introducing a first roll of foil along a first set of rollers and a second roll of foil along a second set of rollers into the welding assembly. In some embodiments, the drug delivery device may include an autoinjector. In some embodiments, the component for the drug delivery device may include at least one of a compression spring or a power spring. In other embodiments, the predefined distance between the first subsection and the second subsection may be adjustable based on at least a dimension of the component for the drug delivery device.

In some embodiments, moving the first and second sheets of foil downward may further comprise clamping the first and second sheets of foil between a first jaw and a second jaw of a transporting assembly at the first welded subsection, moving the first and second jaws of the transporting assembly downward, and unclamping the first and second jaws. In some embodiments, the first and second welding bars of the welding assembly may be moveable along an x-axis (i.e., laterally or horizontally), and the first and second jaws of the transporting assembly may be moveable along the x-axis and a y-axis (i.e., longitudinally or vertically)

In accordance with another aspect of the present disclosure, a method of unloading components for a drug delivery device from foil packaging comprises loading a foil packaging onto a belt of an unloading assembly. The foil packaging may include a first sheet of foil and a second sheet of foil defining a plurality of alternating welded and unwelded subsections. The components for the drug delivery device may be individually packaged in the unwelded subsections using the method of foil packaging components discussed above. The method of unloading components for a drug delivery device also comprises pressing the foil packaging on the belt using a vertical clamp of the unloading assembly, pushing a rod of the unloading assembly through an unwelded subsection of the plurality of unwelded subsections to remove a respective component of the drug delivery device packaged therein, retracting the rod from the unwelded subsection, lifting the vertical clamp from the foil packaging, and moving the foil packaging on a set of rollers of the unloading assembly such that a subsequent unwelded subsection of the plurality of unwelded subsections is aligned with a position of the rod of the unloading assembly.

In some embodiments, the method may further comprise repeating the steps of pressing the foil packaging on the belt using the vertical clamp, pushing the rod through an unwelded subsection to remove a respective component of the drug delivery device packaged therein, retracting the rod from the unwelded subsection, lifting the vertical clamp, and moving the foil packaging on the set of rollers such that a subsequent unwelded subsection is aligned with the position of the rod until each of the components packaged in the foil packaging is unloaded. In some embodiments, the rod of the unloading assembly is moveable along a z-axis.

In some embodiments, prior to pushing the rod through the unwelded subsection to remove the respective component packaged therein, the method may further comprise detecting, using a sensor, a presence of the respective component in the unwelded subsection. In some embodiments, the sensor may comprise an optical sensor or a magnetic sensor. In other embodiments, the method may further comprise controlling an air pressure valve coupled to the rod to provide air into the unwelded subsection while the rod is pushed through the unwelded subsection to remove the respective component packaged therein.

In accordance with another embodiment of the present disclosure, a system for foil packaging components for a drug delivery device comprises a first set of rollers configured to introduce or guide a first sheet of foil, a second set of rollers configured to introduce or guide a second sheet of foil, a welding assembly configured to receive the first and second sheets of foil and weld the first and second sheets of foil at a plurality of subsections thereof to define a plurality of welded subsections, an arm configured to position a component for a drug delivery device between the first and second sheets of foil in the welding assembly, and a transporting assembly operably coupled to the welding assembly and including a first jaw and a second jaw moveable along the x-axis and a y-axis. The welding assembly may include a first welding bar and a second welding bar moveable along an x-axis. The first and second jaws of the transporting assembly may be configured to clamp the first and second sheets of foil at the welded subsections to move the first and second sheets of foil, thereby positioning a subsequent subsection of the plurality of subsections between the first welding bar and the second welding bar for welding.

In some embodiments, the system may further comprise a first set of motors configured to control a movement of the first and second welding bars of the welding assembly, a second set of motors configured to control a movement of the first and second jaws of the transporting assembly, and a controller operably coupled to the first set of motors and the second set of motors. The controller may be configured to control the second set of motors such that the movement of the first and second jaws is synchronized. In some embodiments, the controller may be configured to control the first set of motors such that the movement of the first and second welding bars is synchronized. In yet another embodiment, the controller may be configured to control the first set of motors such that the plurality of welded subsections are offset from each other by a predefined distance. The predefined distance may be adjustable based on at least a dimension of the component for the drug delivery device. In some embodiments, the drug delivery device may include an autoinjector. In other embodiments, the component for the drug delivery device may include at least one of a compression spring or a power spring.

In accordance with yet another embodiment of the present disclosure, a system for unloading components for a drug delivery device from foil packaging comprises an unloading assembly including a belt configured to support at least a portion of a foil packaging thereon, a plurality of rollers configured to receive the foil packaging from the belt and move the foil packaging away from the belt, a vertical clamp operably coupled to the unloading assembly, and a rod moveable along a z-axis and configured to push through unwelded subsections of the foil packaging to remove a respective component of the drug delivery device accommodated therein. The foil packaging may define a plurality of alternating welded and unwelded subsections, and each of the unwelded subsections may be configured to accommodate a component for a drug delivery device therein. The vertical clamp may be configured to move along a y-axis to press a section of the foil packaging on the belt.

In some embodiments, the system may further comprise a first set of motors configured to control a movement of the vertical clamp, a second set of motors configured to control a movement of the rod, a third set of motors configured to control a movement of the plurality of rollers, and a controller operably coupled to the first, second, and third sets of motors. In some embodiments, the controller may be configured to control the first, second, and third sets of motors such that the movement of the vertical clamp, the rod, and the plurality of rollers are synchronized. In other embodiments, the controller may be configured to control the first, second, and third sets of motors such that a position of the rod is aligned with a subsequent unwelded subsections of the plurality of unwelded subsections after removing a respective component from a preceding unwelded subsections of the plurality of unwelded subsections. In some embodiments, the drug delivery device may include an autoinjector. In some embodiments, the component for the drug delivery device may include at least one of a compression spring or a power spring.

In some embodiments, the system may further comprise a sensor configured to detect a presence of a component within an unwelded subsection prior to the rod pushing through the unwelded subsection of the foil packaging to remove the component packaged therein. In some embodiments, the sensor may comprise an optical sensor or a magnetic sensor. In other embodiments, the system may further comprise an air pressure valve operably coupled to the rod. The air pressure valve may be configured to selectively provide air into the unwelded subsections while the rod is pushed through the unwelded subsections to remove the respective component packaged therein.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicative of the presence or absence of particular elements in any of the exemplary embodiments, except as may be explicitly delineated in the corresponding written description. Also, none of the drawings is necessarily drawn to scale.

FIG. 1 illustrates a cross-sectional view of an exemplary drug delivery device, in accordance with various embodiments of the present disclosure.

FIG. 2A illustrates a perspective view of an exemplary system for foil packaging components for a drug delivery device, in accordance with various embodiments of the present disclosure.

FIG. 2B illustrates another perspective view of the exemplary system of FIG. 2A, in accordance with various embodiments of the present disclosure.

FIG. 2C illustrates a front view of the exemplary system of FIG. 2A, in accordance with various embodiments of the present disclosure.

FIG. 3A illustrates the exemplary system of FIG. 2A in a portion of an exemplary foil packaging process, in accordance with various embodiments of the present disclosure.

FIG. 3B illustrates the exemplary system of FIG. 2A in a portion of the exemplary foil packaging process after the portion of the exemplary foil packaging process in FIG. 3A, in accordance with various embodiments of the present disclosure.

FIG. 3C illustrates the exemplary system of FIG. 2A in a portion of the exemplary foil packaging process after the portion of the exemplary foil packaging process in FIG. 3B, in accordance with various embodiments of the present disclosure.

FIG. 3D illustrates the exemplary system of FIG. 2A in a portion of the exemplary foil packaging process after the portion of the exemplary foil packaging process in FIG. 3C, in accordance with various embodiments of the present disclosure.

FIG. 3E illustrates the exemplary system of FIG. 2A in a portion of the exemplary foil packaging process after the portion of the exemplary foil packaging process in FIG. 3D, in accordance with various embodiments of the present disclosure.

FIG. 4 illustrates an exemplary foil packaging, in accordance with various embodiments of the present disclosure.

FIG. 5A illustrates a perspective view of an exemplary system for unloading components for a drug delivery device from foil packaging, in accordance with various embodiments of the present disclosure.

FIG. 5B illustrates another perspective view of the exemplary system of FIG. 5A, in accordance with various embodiments of the present disclosure.

FIG. 5C illustrates another perspective view of the exemplary system of FIG. 5A, in accordance with various embodiments of the present disclosure.

FIG. 5D illustrates a rear view of the exemplary system of FIG. 5A, in accordance with various embodiments of the present disclosure.

FIG. 5E illustrates a top view of the exemplary system of FIG. 5A, in accordance with various embodiments of the present disclosure.

FIG. 6A illustrates a portion of the exemplary system of FIG. 5A, in accordance with various embodiments of the present disclosure.

FIG. 6B illustrates a portion of the exemplary system of FIG. 5A, in accordance with various embodiments of the present disclosure.

FIG. 7 illustrates an exemplary sensor on the exemplary system of FIG. 5A, in accordance with various embodiments of the present disclosure.

FIG. 8 illustrates an exemplary air pressure valve on the exemplary system of FIG. 5A, in accordance with various embodiments of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

The present disclosure generally pertains to drug delivery devices operable by a user for administering a drug, or in the case where the user is the patient, self-administering a drug. Various features are disclosed for simplifying, automating, and/or facilitating certain aspects of injecting a drug, such as those utilized in autoinjectors, on-body injectors, and/or other automatic or partially automatic drug delivery devices (collectively autoinjectors or auto-injectors). For example, these features may include automatically covering a needle in a pre-delivery and/or post-delivery state, automatically activating a drive mechanism, automatically indicating to the user that drug delivery is complete, among other features. One or more of these features may be powered by one or more springs which a user may be required to compress or otherwise charge by pressing a guard against an injection site, for example, to expose a distal end of the needle for insertion into the injection site. The present disclosure provides various configurations and arrangements which alleviate the user from having to maintain, or aid in maintaining, one or more of these springs in a compressed or charged state before, during, and/or after drug delivery. For example, these configurations and arrangements may reduce or eliminate an amount of force that the user must apply to the drug delivery device to hold the guard in a retracted position during drug delivery. As a result, operating the drug delivery device may be simplified and made more reliable for the user. Furthermore, the user may be less likely to remove the needle from the injection site in the midst of drug delivery due to, for example, a sensation that the guard wants to push off of the skin. The chances of successful and complete delivery of the drug are therefore increased. Moreover, a reduced holding force requirement may decrease the likelihood that the user inadvertently moves the needle laterally with respect to the injection site and potentially causes discomfort to the patient. These and other advantages will be apparent to one of ordinary skill in the art reviewing the present disclosure.

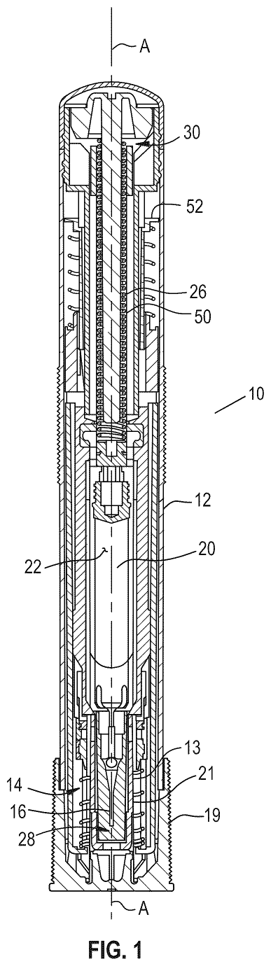

FIG. 1 illustrates a cross-sectional view of an embodiment of a drug delivery device 10 for delivering a drug, which may also be referred to herein as a medicament or drug product. The drug may be, but is not limited to, various biologics such as peptides, peptibodies, or antibodies. The drug may be in a fluid or liquid form, although the present disclosure is not limited to a particular state.

Various implementations and configurations of the drug delivery device 10 are possible. The present embodiment of the drug delivery device 10 is configured as a single-use, disposable injector. In other embodiments, the drug delivery device 10 may be configured as multiple-use reusable injector. The drug delivery device 10 is operable for self-administration by a patient or for administration by caregiver or a formally trained healthcare provider (e.g., a doctor or nurse). The example drug delivery devices shown in the figures may take the form of an autoinjector or pen-type injector, and, as such, may be held in the hand of the user over the duration of drug delivery, but may also or alternatively be suitable for other drug delivery devices and/or configurations.

The drug delivery device 10 may include an outer casing or housing 12. In some embodiments, the housing 12 may be sized and dimensioned to enable a person to grasp the injector 10 in a single hand. The housing 12 may have a generally elongate shape, such as a cylindrical shape, and extend along a longitudinal axis A between a proximal end and a distal end. An opening 14 may be formed in the distal end to permit an insertion end 28 of a delivery member 16, such as a needle or cannula, to extend outside of the housing 12. A transparent or semi-transparent inspection window 17 may be positioned in a wall of the housing 12 to permit a user to view component(s) inside the drug delivery device 10, including a drug storage container 20. Viewing the drug storage container 20 through the window 17 may allow a user to confirm that drug delivery is in progress and/or complete. A removable cap 19 may cover the opening 14 at the distal end of the device prior to use of the drug delivery device 10, and, in some embodiments, may include a gripper 13 configured to assist with removing a removable sterile barrier 21 (e.g., a rigid needle shield (RNS), a non-rigid needle shield (nRNS), etc.) mounted on the insertion end 28 of the delivery member 16. The gripper 13 may include one or more inwardly protruding barbs or arms that frictionally or otherwise mechanically engage the removable sterile barrier 21 to pull the removable sterile barrier 21 with the removable cap 19 when the user separates the removable cap 19 from the housing 12. Thus, removing the removable cap 19 has the effect of removing the removable sterile barrier 21 from the delivery member 16.

In some embodiments, the drug delivery device 10 may include a drive mechanism 30. The drive mechanism 30 may include, among other things, a plunger biasing member 50. The plunger biasing member 50 may include a compression spring (e.g., a helical compression spring) which is initially retained in an energized state. In some embodiments, the plunger biasing member 50 may include a power spring. In the energized state, the plunger biasing member 50 may be compressed such that its axial length is shorter than it would be in a natural or non-energized state, and, as a consequence, the plunger biasing member 50 may exert a distally directed biasing force on a plunger 26 and a proximally directed biasing force on another component(s), which, in some embodiments, may include a releaser member 52. When released, the plunger biasing member 50 may try to expand to its natural axial length, and, as a consequence, push the plunger 26 in the distal direction to expel the drug from the drug storage container 20 through the insertion end 28 of the delivery member 16.

Drug delivery devices, like the drug delivery device 10 illustrated in FIG. 1, include various components, including but certainly not limited to the drug storage container 20, the plunger 26, the plunger biasing member 50, the releaser member 52, the removable cap 19, and the like. Generally, these various components of a drug delivery device are individually manufactured at a manufacturing site and shipped to an assembly site to be assembled together to form a final assembly of the drug delivery device. Conventionally, components for drug delivery devices, such as the plunger biasing member 50, for example, may be individually and manually packaged into plastic trays, and each plastic tray of plunger biasing members 50 may be manually packaged into pallets or boxes. These pallets or boxes of plastic trays may, then, be shipped to an assembly location to be manually unloaded. Generally, the pallets or boxes are discarded as waste. In some instances, some of the plastic trays may be washed and shipped back to the manufacturing location to be re-used. However, some of the plastic trays may be discarded as waste due to damage and wear-and-tear to the trays. Accordingly, conventional systems and methods for packaging components for these drug delivery devices are not only costly since they require continuous production of plastic trays, but they are also not sustainable, particularly in view of the amount of waste (e.g., plastic waste). Moreover, due to the weight of each plastic tray, shipping pallets of these plastic trays may increase shipping cost. In addition, conventional systems and methods may require manual packaging of components before shipping and also require manual unloading of components at the assembly location, which can increase costs for manual labor and can be inefficient, especially for mass production of drug delivery devices. Therefore, there is a need for systems and methods for packaging and unloading components for drug delivery devices that improve reliability, sustainability, production costs, and efficiency.

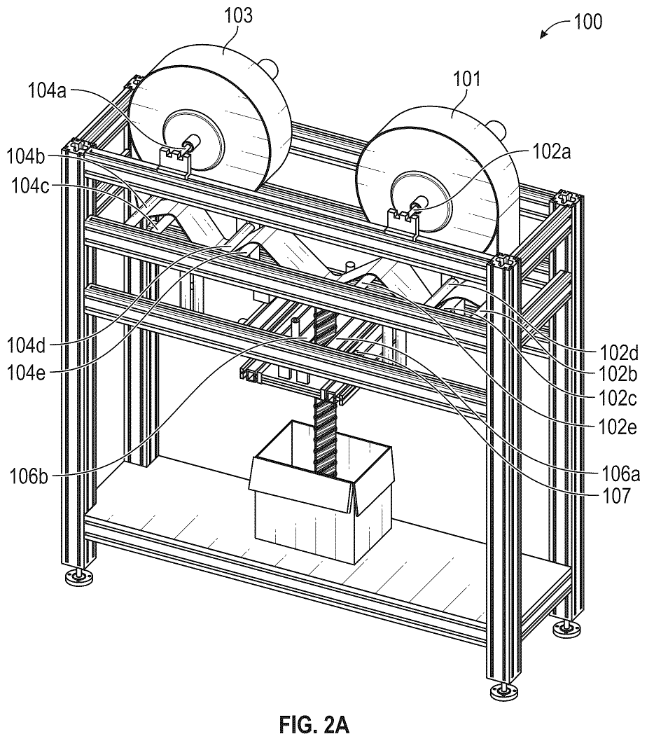

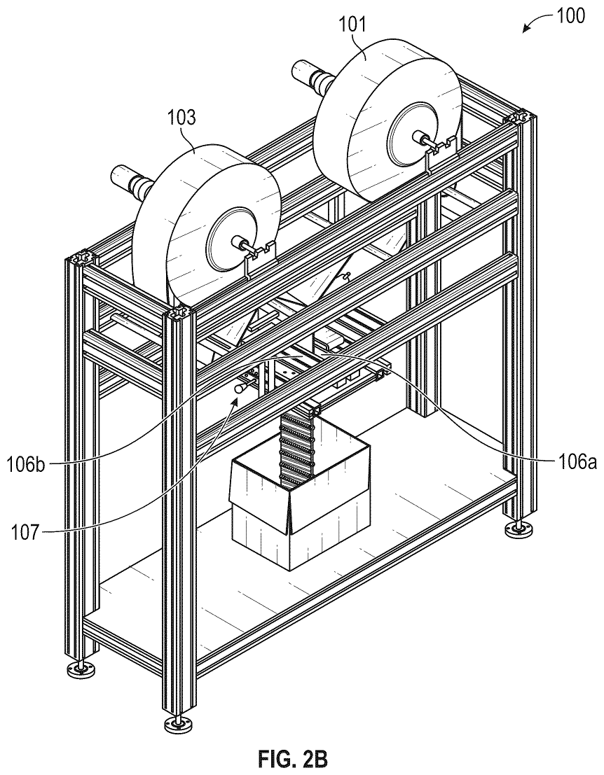

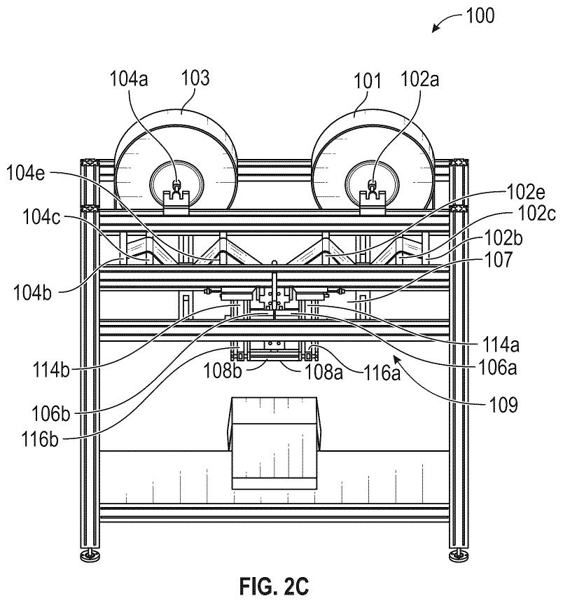

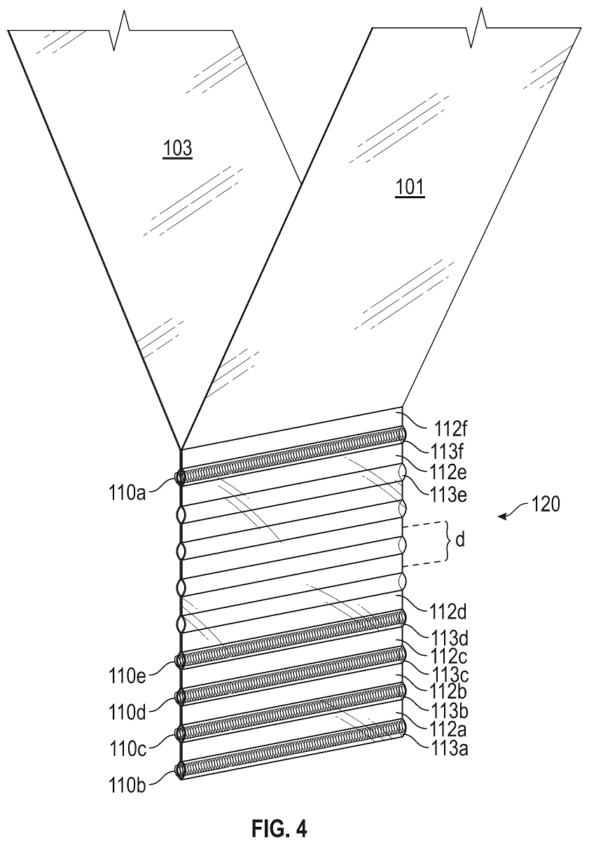

FIGS. 2A-2C illustrate various views of an exemplary system 100 for foil packaging component(s) of a drug delivery device, in accordance with various embodiments of the present disclosure. The system 100 may be a fully automated system or at least a partially automated system. To address one or more of the needs and challenges mentioned above, as well as other needs and challenges, the system 100 uses foil packaging 120 (shown in FIG. 4) to package one or more components of a drug delivery device. In some embodiments, the drug delivery device may include an autoinjector, such as the drug delivery device 10 of FIG. 1. In some embodiments, the component of a drug delivery device may include a compression spring or a power spring, such as the plunger biasing member 50 of the drug delivery device 10 of FIG. 1.

As shown in FIGS. 2A-2C, the system 100 for foil packaging component(s) of a drug delivery device may include a first set of rollers 102a-e configured to introduce or guide the movement of a first roll of foil 101 and a second set of rollers 104a-e configured to introduce or guide the movement of a second roll of foil 103. Although FIGS. 2A-2C illustrate each of the first set of rollers 102a-e and the second set of rollers 104a-e having five rollers, the system 100 is not limited to five rollers for introducing the first roll of foil 101 or the second roll of foil 103. For example, the first set of rollers 102a-e and the second set of rollers 104a-e may each have one roller, two rollers, three rollers, four rollers, six rollers, or seven rollers. The first roll of foil 101 and the second roll of foil may each include a length of foil sheet rolled on a roll. Each foil sheet may have a length of about 5 meters, 10 meters, 15 meters, 20 meters, or the like. In some embodiments, the foil sheet may include high density foil and may be made of a thin sheet of plastic or thermoplastic polymer, such as high density polyethylene (HDPE). In some embodiments, the foil sheet may be manufactured from multiple layers of plastic. In other embodiments, the foil sheet may be manufactured from paper and may be coated with wax or a plastic film. In some embodiments, each foil sheet may have a thickness in a range between about 10 microns and about 90 microns. For example, each foil sheet may have a thickness of about 20 microns, 30 microns, 40 microns, 50 microns, 60 microns, 70 microns, or 80 microns. As discussed in more detail below, each sheet of foil may include a plurality of subsections defining a plurality of welded subsections and a plurality of unwelded subsections.

The system 100 may also include a welding assembly 107 including a first welding bar 106a and a second welding bar 106b. The first welding bar 106a and the second welding bar 106b may be heated e.g., by directing a current therethrough. The width of the first and second welding bars 106a, 106b may span at least the width of each of the first sheet of foil from the first roll of foil 101 and the second sheet of foil from the second roll of foil 103. Moreover, as discussed in more detail below, the height of the first and second welding bars 106a, 106b may be equal to the height of each of the plurality of unwelded subsections (e.g., subsections 113a-f in FIG. 4) and/or each of the plurality of welded subsections (e.g., subsections 112a-f in FIG. 4) of the foil sheets (e.g., foil packaging 120 in FIG. 4). In some embodiments, the first welding bar 106a and the second welding bar 106b may be configured to cooperate to weld the first sheet of foil from the first roll of foil 101 and the second sheet of foil from the second roll of foil 103 together at one or more subsections.

In some embodiments, the system 100 may contemplate using other methods of joining the first sheet of foil from the first roll of foil 101 and the second sheet of foil from the second roll of foil 103 together at one or more subsections to provide the foil packaging 120 (shown in FIG. 4). For example, instead of welding the two sheets of foil at one or more subsections, the system 100 may join the two sheets of foil at one or more subsections by using adhesives, by ultrasound or friction welding, or sewing.

As shown in FIG. 2C, the system 100 may further include a transporting assembly 109 operably coupled to the welding assembly 107. The transporting assembly 109 may include a first jaw 108a and a second jaw 108b. The transporting assembly 109 may be disposed vertically downstream from the welding assembly 107 in the system 100. Accordingly, after the first welding bar 106a and the second welding bar 106b join the first sheet of foil and the second sheet of foil together at one or more subsections, the first jaw 108a and the second jaw 108b may be configured to clamp the welded subsection(s) of the joined sheets of foil and move the joined sheets of foil vertically downward to thereby position a subsequent subsection of the first and second sheets of foil between the first welding bar 106a and the second welding bar 106b for welding. The first welding bar 106a and the second welding bar 106b may be moveable along the x-axis (i.e., horizontally or laterally) to contact the first and second sheets of foil and weld the sheets of foil together at one or more subsections. The first jaw 108a and the second jaw 108b may be moveable along the x-axis (i.e., horizontally or laterally) and along the y-axis (i.e., vertically or longitudinally). Accordingly, the first jaw 108a and the second jaw 108b may be configured to move along the x-axis to clamp onto the welded subsection(s) of the joined foil sheets and move along the y-axis to move the joined foil sheets vertically downward. In some embodiments, the width of the first and second jaws 108a, 108b may span at least the width of each of the first sheet of foil from the first roll of foil 101 and the second sheet of foil from the second roll of foil 103. Moreover, as discussed in more detail below, the height of the first and second jaws 108a, 108b may be equal to the height of each of the plurality of unwelded subsections (e.g., subsections 113a-f in FIG. 4) and/or each of the plurality of welded subsections (e.g., subsections 112a-f in FIG. 4) of the foil sheets (e.g., foil packaging 120 in FIG. 4).

In some embodiments, the system 100 may include a first set of motors 114a and 114b configured to control a movement of the first welding bar 106a and the second welding bar 106b, respectively. In addition, the system 100 may include a second set of motors 116a and 116b configured to control a movement of the first jaw 108a and the second jaw 108b. In some embodiments, the system 100 may include a programmable controller operably coupled to the first set of motors 114a, 114b and the second set of motors 116a, 116b. For example, the controller may be programmed to control the first set of motors 114a, 114b to move the first and second welding bars 106a, 106b, respectively. In some embodiments, the controller may be programmed to control the first set of motors 114a, 114b such that movement of the first and second welding bars 106a, 106b are substantially synchronized and such that the first and second welding bars 106a, 106b may be configured to contact the first and second sheets of foil substantially simultaneously to weld the first and second sheets of foil together.

In some embodiments, the controller may be programmed to control the frequency of the movement of the first and second welding bars 106a, 106b, as well as the time duration in which the first and second welding bars 106a, 106b are in contact with the first and second sheets of foil for welding. For example, the controller may be programmed to control the first set of motors 114a and 114b such that the first and second welding bars 106a, 106b clamp the first and second sheets of foil for welding approximately every 0.5 seconds, every 1 second, every 2 seconds, every 3 seconds, every 4 seconds, every 5 seconds, or every 10 seconds. Additionally, the controller may be programmed to control the first set of motors 114a, 114b such that the first and second welding bars 106a, 106b stay in contact with the first and second sheets of foil to weld them together for about 0.5 seconds, 1 second, 2 seconds, 3 seconds, 4 seconds, or 5 seconds.

As discussed in more detail below, the controller may additionally be programmed to control the first set of motors 114a, 114b and/or the second set of motors 116a, 116b such that any two adjacent or subsequent welded subsections in the first and second sheets of foil are offset from each other by a predefined distance “d” (shown in FIG. 4). The predefined distance may be adjustable based on various factors, including but not limited to a size or a dimension (e.g., width) of the component for the drug delivery device to be packaged in the foil packaging, such as foil packaging 120 in FIG. 4. By way of example, in the case of foil packaging plunger biasing members 50 of the drug delivery device 10 of FIG. 1, the predefined distance between any two adjacent of subsequent welded subsections may be based at least on the width of the plunger biasing members 50.

In other embodiments, the controller may be programmed to control the second set of motors 116a, 116b to move the first and second jaws 108a, 108b, respectively. In some embodiments, the controller may be programmed to control the second set of motors 116a, 116b such that movement of the first and second jaws 108a, 108b are substantially synchronized and such that the first and second jaws 108a, 108b may be configured to contact the joined sheets of foil substantially simultaneously to clamp the joined sheet of foil and move the joined sheets of foil vertically downward.

In some embodiments, the controller may be programmed to control the frequency of the movement of the first and second jaws 108a, 108b. For example, the controller may be programmed to control the second set of motors 116a and 116b such that the first and second jaws 108a, 108b clamp the joined sheets of foil approximately every 0.5 seconds, every 1 second, every 2 seconds, every 3 seconds, every 4 seconds, every 5 seconds, or every 10 seconds. Additionally, the controller may be programmed to control the second set of motors 116a, 116b such that the first and second jaws 108a, 108b stay in contact with the joined sheets of foil to move them downward for about 0.5 seconds, 1 second, 2 seconds, 3 seconds, 4 seconds, 5 seconds, or 10 seconds. In some embodiments, the controller may be programmed to synchronize the movement of the first and second jaws 108a, 108b with the movement of the first and second welding bars 106a, 106b.

In some embodiments, instead of having two motors 114a, 114b each configured to control a movement of a respective one of the first and second welding bars 106a, 106b, the system 100 may include one motor configured to control the movement of both of the first and second welding bars 106a, 106b. Similarly, in some embodiments, instead of having two motors 116a, 116b each configured to control a movement of a respective one of the first and second jaws 108a, 108b, the system 100 may include one motor configured to control the movement of both of the first and second jaws 108a, 108b.

By automating the process of packaging components for a drug delivery device in foil packaging, the system 100 may be configured to package up to approximately 120 components, such as plunger biasing members 50, per minute into foil packaging. For example, the system 100 may be able to package 1000 compression springs or power springs in 10 meters of foil packaging in approximately 9 minutes. Accordingly, the system 100 may not only reduce or eliminate the labor costs associated with manually packaging each individual component, but the system 100 may also significantly increase the efficiency of packaging components using a fully automated or partially automated system. Moreover, because the components are packaged in foil packaging made of thins sheets of foil instead of, for example, plastic trays, the system 100 can reduce the amount of waste discarded from shipping the components to an assembly location, thereby improving sustainability.

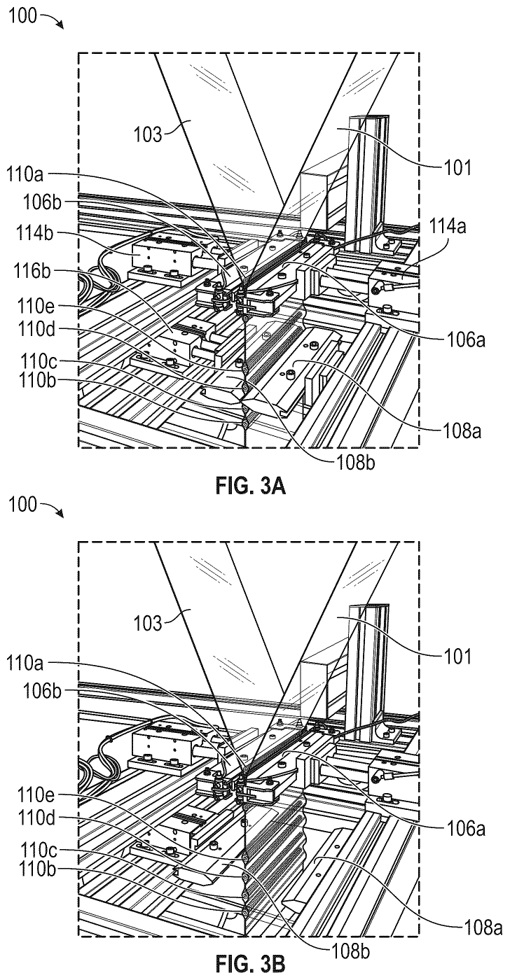

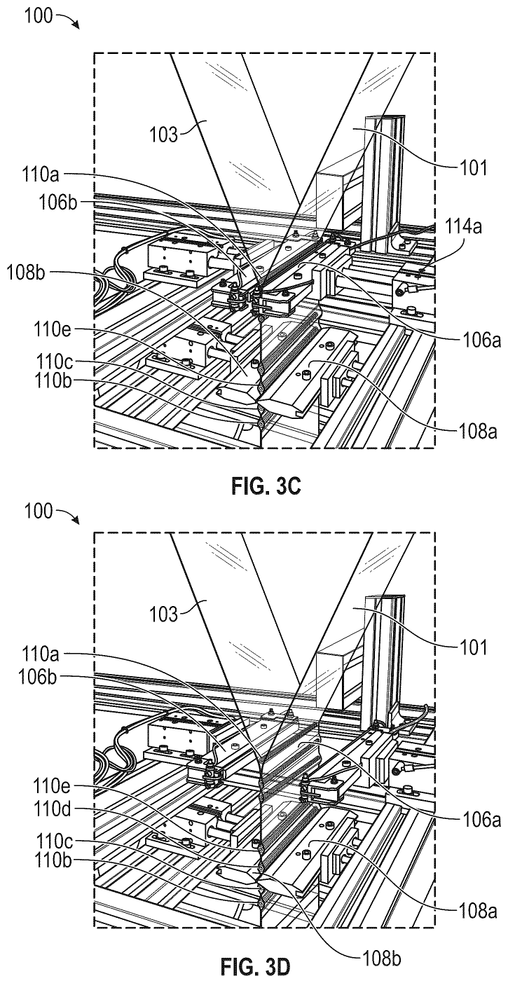

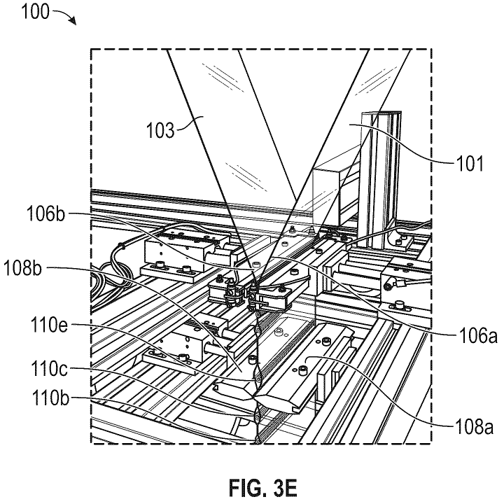

Referring to FIGS. 3A-3E and FIG. 4, an exemplary method for foil packaging components for a drug delivery device using the system 100 of FIGS. 2A-2C, in accordance with various embodiments of the present disclosure, is explained. As shown in FIG. 3A, the system 100 includes a first sheet of foil from the first roll of foil 101 and a second sheet of foil from the second roll of foil 103 disposed between the first welding bar 106a and the second welding bar 106b of the welding assembly 107. In some embodiments, the first set of rollers 102a-e may be configured to introduce or guide the first sheet of foil along the first set of rollers 102a-e, and the second set of rollers 104a-e may be configured to introduce or guide the second sheet of foil along the second set or rollers 104a-e into the welding assembly 107 such that the first and second sheets of foil are positioned between the first and second welding bars 106a, 106b.

FIG. 3A illustrates the system 100 of FIGS. 2A-2C when the first and second welding bars 106a, 106b are welding the first and second sheets of foil together at a first subsection (subsection 112e in FIG. 4). Accordingly, the first and second welding bars 106a, 106b are clamping the first and second sheets of foil together to weld the first and second sheets of foil together at the first subsection (subsection 112e in FIG. 4) and form a welded subsection. FIG. 3A also illustrates the first and second jaws 108a, 108b of the transporting assembly 109 clamping one of the previously welded subsections (subsection 112b in FIG. 4) of the joined first and second sheets of foil positioned farther downstream on the foil packaging.

While the first and second welding bars 106a, 106b are welding the first and second sheets of foil together at the subsection in FIG. 3A, a component 110a for a drug delivery device may be provided or placed between the first sheet of foil from the first roll of foil 101 and the second sheet of foil from the second roll of foil 103. By way of example, the component 110a may be the plunger biasing member 50 (e.g., compression spring or power spring) of the drug delivery device 10. Although not shown in these figures, the system 100 may include a motorized arm operably coupled to the welding assembly and configured to provide or place the component for the drug delivery device between the first sheet of foil from the first roll of foil 101 and the second sheet of foil from the second roll of foil 103.

After the first and second welding bars 106a, 106b have completed welding the first and second sheets of foil together at the first subsection in FIG. 3A (subsection 112e in FIG. 4), the first and second jaws 108a, 108b may be configured to move horizontally outward and unclamp from the joined first and second sheets of foil, as shown in FIG. 3B. Additionally, as shown in FIG. 3C, the first and second jaws 108a, 108b may be configured to move vertically upward and, then, horizontally inward to clamp the joined first and second sheets of foil at the subsequent welded subsection (subsection 112c in FIG. 4) positioned adjacently upstream from subsection 112b in FIG. 4. Once the first and second jaws 108a, 108b have clamped the joined first and second sheets of foil at the subsequent welded subsection 112c (FIG. 4), as shown in FIG. 3D, the first and second welding bars 106a, 106b may be configured to unclamp from the first subsection (subsection 112e in FIG. 4). After unclamping the first and second welding bars 106a, 106b, the first and second jaws 108a, 108b may be configured to move vertically downward to move the first and second sheets of foil downward in the welding assembly 107, thereby exposing the subsequent, adjacent subsection (subsection 112f in FIG. 4) in each of the first and second foil sheets for welding. For example, as shown in FIG. 3E, the first and second welding bars 106a, 106b may be configured to move horizontally inward and clamp the first and second foil sheets to weld the first and second foil sheets together at the subsequent, adjacent subsection 112f.

The steps mentioned above with reference to FIGS. 3A-3E may be repeated a plurality of times to create a foil packaging of components for the drug delivery device, such as the foil packaging 120 shown in FIG. 4. Accordingly, referring to FIG. 4, the steps of (a) welding the first and second sheets of foil together at subsection 112e by clamping the first and second welding bars 106a, 106b, (b) providing the component 110a for the drug delivery device between the first and second sheets of foil, (c) unclamping the first and second jaws 108a, 108b from subsection 112b, (d) moving the first and second jaws 108a, 108b to clamp the first and second sheets of foil at subsection 112c, (e) moving the first and second jaws 108a, 108b vertically downward to move the first and second sheets of foil downward in the welding assembly 107, and (f) welding the first and second sheets of foil together at subsection 112f by clamping the first and second welding bars 106a, 106b may be repeated until each of the components 110a-e for the drug delivery device is individually packaged in foil packaging.

Although FIGS. 3A-3E illustrate the first welding bar 106a and the second welding bar 106b spanning substantially the entire width of the first and second sheets of foil, in some embodiments, the length of each of the first welding bar 106a and the second welding bar 106b may be less than the width of the first and second sheets of foil such that, when the first and second sheets of foil are welded together, the welded subsections 112a-f (shown in FIG. 4) span only a portion of the width of the foil packaging 120. In other embodiments, the first welding bar 106a and the second welding bar 106b may each have a plurality of contact points such that when the first welding bar 106a and the second welding bar 106b are joined together to weld the first and second sheets of foil, the welded subsections 112a-f each include a plurality of welded dots or sections that are joined together.

As shown in FIG. 4, each component of the plurality of components 110a-e for the drug delivery device is individually packaged in foil packaging such that each component is separated and individually surrounded by the foil packaging. That is, by way of example, a first welded subsection 112e is on one side of the component 110a, and the second welded subsection 112f is one the opposite side of the component 110a such that the component 110a is surrounded by the first and second sheets of foil after welding at subsections 112e, 112f.

The foil packaging 120 shown in FIG. 4 includes a plurality of welded subsections 112a-f and a plurality of unwelded subsections 113a-f alternating with each other. Each of the welded subsections 112a-f and each of the unwelded subsections 113a-f may be offset a predefined distance “d” from each other such that any two adjacent welded subsections or any two adjacent unwelded subsections are offset a predefined distance “d” from each other. Accordingly, as discussed above, the controller may be programmed to control the second set of motors 116a, 116b to move the first and second jaws 108a, 108b the predefined distance “d” vertically upward or downward to maintain the predefined distance “d” between any two adjacent welded subsections or any two adjacent unwelded subsections. The predefined distance “d” may be adjustable. By way of example, the predefined distance “d” may be based at least on the size or dimension (e.g., width) of the components 110a-e for the drug delivery device such that each of the components 110a-e can be moveably accommodated inside each respective unwelded subsection of the plurality of unwelded subsections 113a-f.

While FIGS. 2A-2C and 3A-3E illustrate the system 100 welding the first sheet of foil from the first roll of foil 101 and the second sheet of foil from the second roll of foil 103 together to form the foil packaging 120, the foil packaging 120 may be made from only one roll of foil. For example, the foil packaging 120 may be made by folding one roll of foil in half and welding around each one of the components, such as components 110a-e, packaged therein. Additionally, or alternatively, while the horizontal ends of the foil packaging 120 illustrated in FIG. 4 are opened to allow the components 110a-e therein to freely move within respective unwelded subsections 113a-f, in some embodiments, the sides of the foil packaging 120 may be welded together as well such that the components 110a-e are fully enclosed in the foil packaging 120 and cannot fall out of the respective unwelded subsections 113a-f. One or both of the horizontal ends can be later cut or removed prior to unloading the components 110a-e therein.

In some embodiments, the foil packaging 120 may be pre-loaded with the components 110a-e therein without having to use the system 100 to load each of the components 110a-e within the foil packaging 120. Accordingly, the pre-loaded foil packaging 120 may be provided to the system 200 for unloading, as described in more detail below.

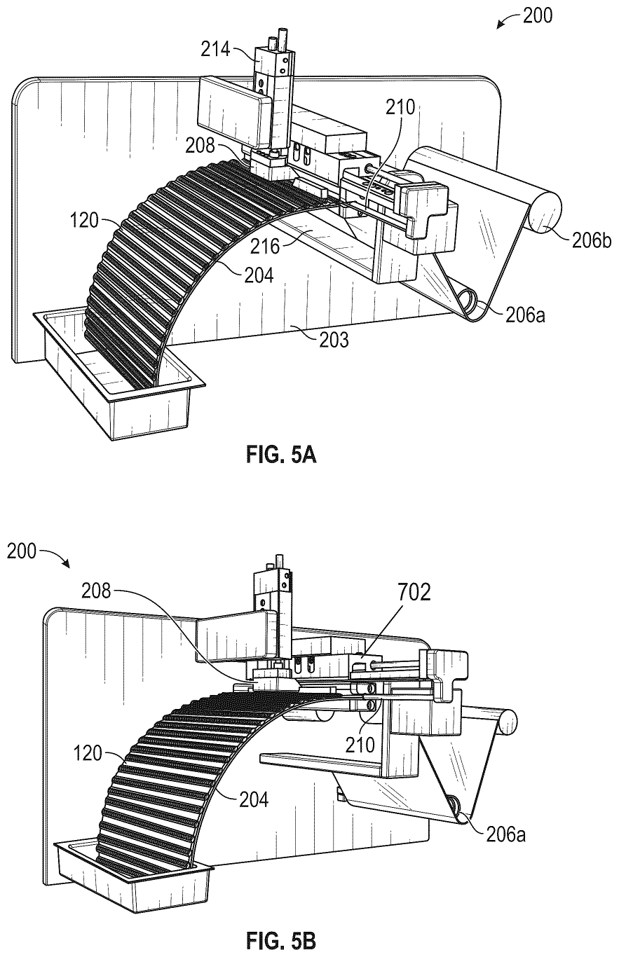

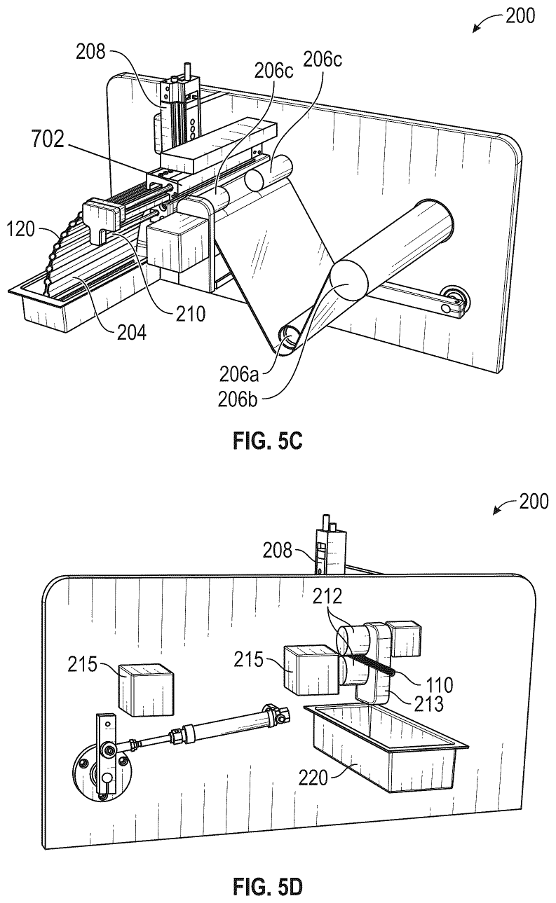

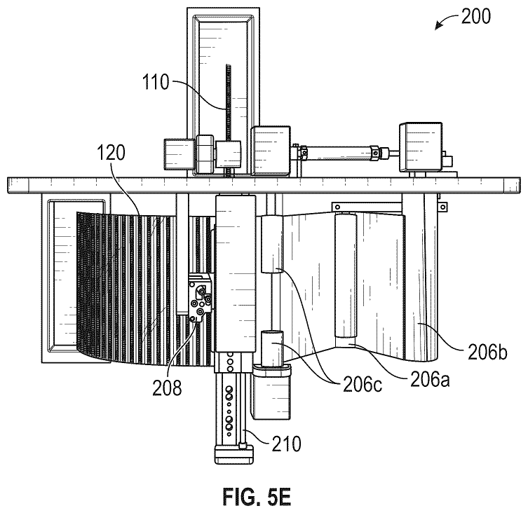

FIGS. 5A-5E illustrate various views of an exemplary system 200 for unloading component(s) for a drug delivery device from foil packaging, such as foil packaging 120 in FIG. 4, in accordance with various embodiments of the present disclosure. The system 200 may be a fully automated system or at least a partially automated system. To address one or more of the needs and challenges mentioned above, as well as other needs and challenges, the system 200 provides an automated system for unloading component(s), such as plunger biasing member 50, for a drug delivery device from foil packaging, such as foil packaging 120 in FIG. 4. In some embodiments, the drug delivery device may include an autoinjector, such as the drug delivery device 10 of FIG. 1. In some embodiments, the component of a drug delivery device may include a compression spring or a power spring, such as the plunger biasing member 50 of the drug delivery device 10 of FIG. 1.

As shown in FIGS. 5A-5E, the system 200 may include an unloading assembly 203 including a metal belt 204 configured to support at least a portion of the foil packaging 120 thereon. The system 200 may further include a plurality of rollers 206a-c configured to receive the foil packaging 120 from the belt 204 and guide the movement of the foil packaging 120 in a direction generally away from the belt 204. By way of example, the plurality of rollers 206a-c may be operably coupled to one or more motors that are configured to rotate the plurality of rollers 206a-c to move the foil packaging 120 along in a direction generally away from the belt 204. The system 200 may also include a rod 210 operably coupled to the unloading assembly 203. In some embodiments, the rod 210 may be a metal rod. The rod 210 may be operably coupled to one or more motors and may be configured to move along the z-axis (i.e., perpendicular to a vertical plane that is parallel to the unloading assembly 203). The rod 210 may be configured to move along the z-axis to enter and push through one or more of the unwelded subsections of the foil packaging (e.g., unwelded subsections 113a-f of foil packaging 120 in FIG. 4) to thereby remove a respective component (e.g., components 110a-e in FIG. 4) accommodated therein. Additionally, the system 200 may include a vertical clamp 208 operably coupled to the unloading assembly 203. The vertical clamp 208 may be operably coupled to one or more motors and may be configured to move along the y-axis (i.e., vertically or longitudinally) to press a subsection of the foil packaging 120 onto the belt 204. By way of example, during the unloading operation, the vertical clamp 208 may be configured to press down on the unwelded subsection 113c (shown in FIG. 4) of the foil packaging 120 to keep the foil packaging 120 stable on the belt 204. While the vertical clamp 208 is pressing down on the unwelded subsection 113c, the rod 210 may be configured to move along the z-axis and push through the unwelded subsection 113c to remove the respective component 110d of the drug delivery device that is accommodated therein. The system 200 may be configured to repeat these steps until all of the components packaged in the foil packaging 120 are removed from the foil packaging 120.

In some embodiments, the system 200 may further comprise a first set of motors 214 operably coupled to the vertical clamp 208 and configured to control a vertical movement of the vertical clamp 208. The system 200 may also comprise a second set of motors 216 operably coupled to the rod 210 and configured to control a movement of the rod 210 along the z-axis (i.e., into and out of the unwelded subsections of the foil packaging). Additionally, the system 200 may comprise a third set of motors 215 (shown in FIG. 5D) operably coupled to the plurality of rollers 206a-c and configured to control a movement or rotation of the plurality of rollers 206a-c. The first set of motors 214, second set of motors 216, and third set of motors 215 may be operably coupled to a programmable controller.

In some embodiments, the controller may be programmed to control the first set of motors 214, second set of motors 216, and third set of motors 215 to control the movement of the vertical clamp 208, the rod 210, and the rollers 206a-c, respectively. By way of example, the controller may be programmed to control the first set of motors 214, second set of motors 216, and third set of motors 215 such that movements of the vertical clamp 208, the rod 210, and the rollers 206a-c are synchronized. Referring to FIG. 4, for example, the controller may be programmed to control the first set of motors 214, second set of motors 216, and third set of motors 215 such that, after removing the component 110b from the unwelded subsection 113a of the foil packaging 120, the rollers 206a-c move the foil packaging 120 a predefined distance along the belt 204 such that the position of the rod 210 is aligned with a subsequent unwelded subsection 113b. Accordingly, the rod 210 can push through the unwelded subsection 113b to remove the component 110c. Moreover, the controller may be programmed to control the first set of motors 214, second set of motors 216, and third set of motors 215 such that, after removing the component 110b from the unwelded subsection 113a of the foil packaging 120, the vertical clamp 208 pushes down on the subsequent unwelded subsection 113b to keep the foil packaging 120 stable while the rod 210 pushes through the subsection 113b.

In some embodiments, the controller may be programmed to control the third set of motors 215 such that the rollers 206a-c are continuously rotating while the system 200 is powered on. In other embodiments, the controller may be programmed to control and/or synchronize the first set of motors 214 and the third set of motors 215 such that the third set of motors 215 rotates the rollers 206a-c only after the first set of motors 214 lifts the vertical clamp 208 off the foil packaging 120 and before the first set of motors 214 pushes the vertical clamp 208 downward onto the foil packaging 120 (i.e., the rollers 206a-c may only rotate when the vertical clamp 208 is not in contact with the foil packaging 120). Additionally, or alternatively, the controller may be programmed to control and/or synchronize the first set of motors 214 and the second set of motors 216 such that the second set of motors 216 pushes the rod 210 through an unwelded subsection of the foil packaging 120 immediately after the first set of motors 214 pushes the vertical clamp 208 downward onto the foil packaging 120 (i.e., the rod 210 pushes through an unwelded subsection only when the vertical clamp 208 is in contact with the foil packaging 120).

In some embodiments, the controller may be programmed to control the frequency of the movement of the vertical clamp 208, as well as the time duration in which the vertical clamp 208 is in contact with a portion of the foil packaging 120. For example, the controller may be programmed to control the first set of motors 214 such that the vertical clamp 208 moves downward to push a portion of the foil packaging 120 on the belt 204 approximately every 0.25 seconds, every 0.5 seconds, every 1 second, every 2 seconds, every 3 seconds, every 4 seconds, or every 5 seconds. Additionally, the controller may be programmed to control the first set of motors 214 such that, once the vertical clamp 208 moves downward to push a portion of the foil packaging 120 on the belt 204, the vertical clamp 208 stays in contact with the portion of the foil packaging 120 for about 0.25 seconds, 0.5 seconds, 1 second, 2 seconds, 3 seconds, 4 seconds, or 5 seconds.

The controller may also be programmed to control the frequency of the movement of the rod 210, as well as the time it takes for the rod 210 to push completely through an unwelded subsection of the foil packaging 120 and completely out of the unwelded subsection of the foil packaging 120. By way of example, the controller may be programmed to control the second set of motors 216 such that the rod 210 pushes through and out of an unwelded subsection, such as unwelded subsection 113c in FIG. 4, of the foil packaging 120 approximately every 0.25 seconds, every 0.5 seconds, every 1 second, every 2 seconds, every 3 seconds, every 4 seconds, or every 5 seconds. The controller may also be programmed to control the second set of motors 216 such that the time it takes for the rod 210 to push through and out of an unwelded subsection is about 0.25 seconds, 0.5 seconds, 1 second, 2 seconds, 3 seconds, 4 seconds, or 5 seconds. Accordingly, the system 200 may be configured to unload up to approximately 120 components, such as plunger biasing members 50, per minute from the foil packaging.

Furthermore, the controller may be programmed to control the speed of rotation of one or more of the rollers 206a-c and control the speed at which the foil packaging 120 moves across the unloading system 200. For example, the controller may be programmed to control the rotational speed of one or more of the rollers 206a-c such that the foil packaging 120 moves away from the belt 204 and across the unloading system 200 at approximately 0.01 meters of foil packaging per second, 0.02 meters per second, 0.03 meters per second, 0.04 meters per second, or 0.05 meters per second.

As shown in FIGS. 5D and 5E, for example, the system 200 may further include a second plurality of rollers 212 on the rear side of the unloading assembly 203. The system 200 may include a set of motors 213 operably coupled to the second plurality of rollers 212. Moreover, the controller may be configured to control the motor(s) 213 to control the rotational speed of the second plurality of rollers 212. When the rod 210 pushes through an unwelded subsection of the foil packaging 120 to remove a component 110 from the foil packaging 120, the component 110 may be directed towards the rear side of the unloading assembly 203 before being dropped into a container 220. Accordingly, the controller may be programmed to control the motor(s) 213 such that as the component 110 is pushed out of the foil packaging and directed towards the rear side of the unloading assembly 203, the second plurality of rollers 212 rotate in opposite directions to move the component 110 therebetween towards the container 220. The rotational speed of the plurality of rollers 212 may be adjustable based on the speed of the rod 210, the speed of the vertical clamp 208, and/or the rotational speed of the plurality of rollers 206a-c. In some embodiments, the speed of the rod 210, the speed of the vertical clamp 208, the rotational speed of the rollers 206a-c, and the rotational speed of the plurality of rollers 212 may be interdependent on each other to control the process of unloading the components from the foil packaging.

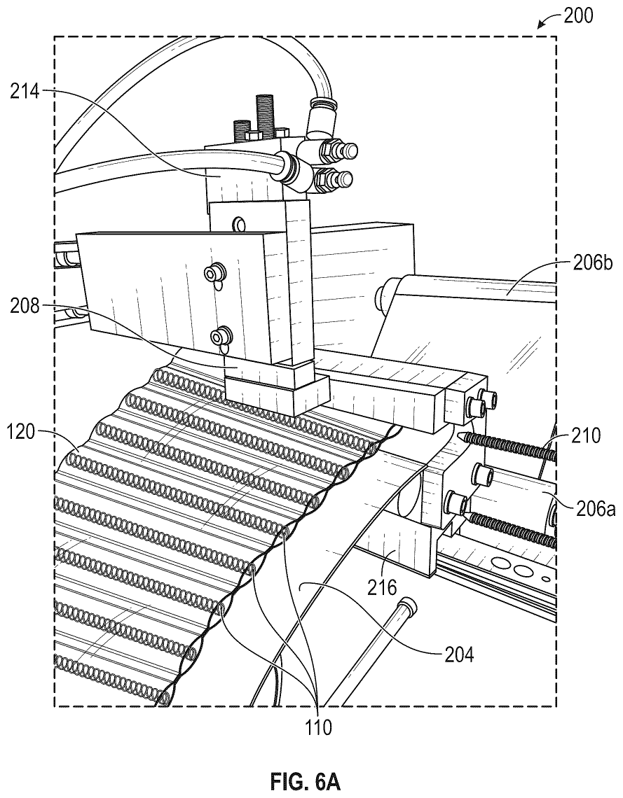

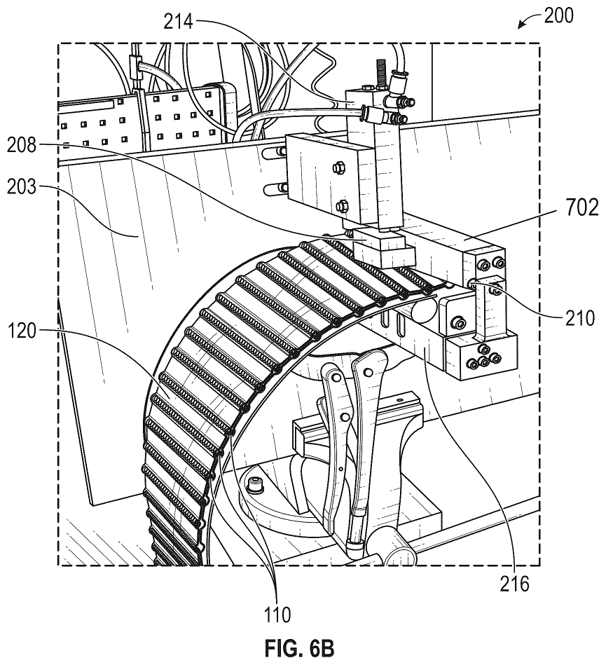

Referring now to FIGS. 6A-6B and FIG. 4, the method of unloading components for a drug delivery device from foil packaging 120 using the system 200 of FIGS. 5A-5E, in accordance with various embodiments of the present disclosure, is explained. As shown in FIGS. 6A and 6B, the foil packaging 120 with a plurality of components 110 packaged therein is loaded onto the belt 204 of the unloading assembly 203. The foil packaging 120 in FIGS. 6A and 6B is identical to the foil packaging 120 in FIG. 4. Accordingly, the components 110a-e illustrated in FIG. 4 may be some of the plurality of components 110 illustrated in FIGS. 6A and 6B. As shown in FIG. 4, the foil packaging 120 includes a plurality of alternating welded subsections 112a-f and unwelded subsections 113a-f. The components 110a-e (as well as components 110 in FIGS. 6A and 6B) are individually packaged in respective unwelded subsections 113a-f using, for example, the system 100 discussed above.

Once the foil packaging 120 is loaded onto the belt 204 of system 200, the controller may be configured to control the first set of motors 214 to move the vertical clamp 208 downward and press the foil packaging 120 on the belt 204 to keep the foil packaging 120 stable. By way of example, the vertical clamp 208 may move downward to press on one of the unwelded subsections, such as unwelded subsection 113b (shown in FIG. 4) of the foil packaging 120. Afterwards, the controller may be configured to control the second set of motors 216 to move the rod 210 in the z-axis direction. Accordingly, the second set of motors 216 may be configured to push the rod 210 through the unwelded subsection 113b to remove the respective component 110c (shown in FIG. 4) packaged therein. At least while the rod 210 pushes through the unwelded subsection 113b, the controller may be configured to control the motor(s) 213 (shown in FIG. 5D) to rotate the second plurality of rollers 212 in opposite directions such that the component 110c can be pushed through the unloading assembly 203 and into the container 220.

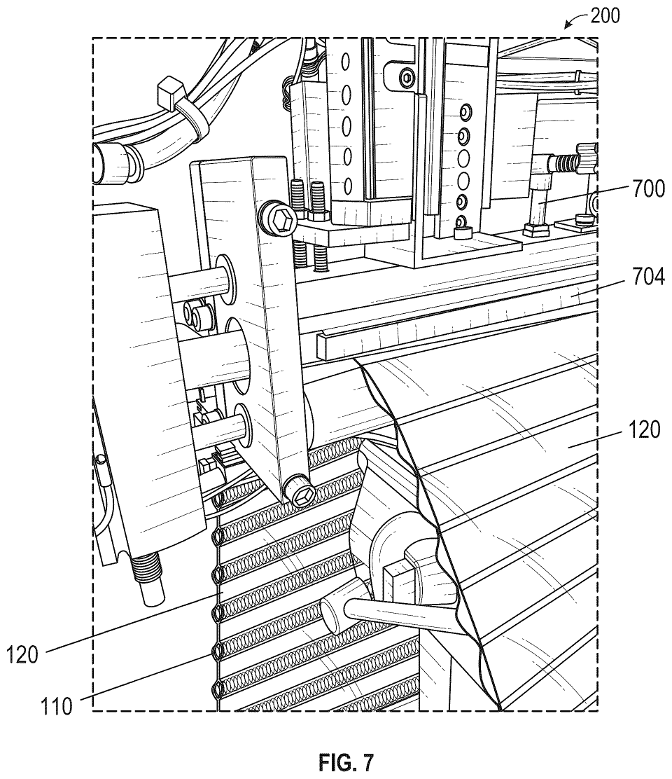

In some embodiments, the system 200 may further comprise a sensor 700, as shown in FIG. 7, disposed axially above the rod 210. The sensor 700 may be a magnetic sensor, an optical sensor, or any other sensor that is capable of detecting a presence of an object. In some embodiments, the sensor 700 may be operably coupled to the controller. For example, the sensor 700 may be in wired or wireless communication with the controller such that the sensor 700 can transmit data to the controller, and the controller can receive data from the sensor 700. While FIG. 7 illustrates the system 200 having one sensor 700, the system 200 can have any number of sensors 700. For example, the system 200 may comprise two, three, four, or five sensors 700.

The sensor 700 may be configured to identify whether a component is present within a particular unwelded subsection of the foil packaging 120 before the rod 210 is pushed through the unwelded subsection to remove the component therein. Accordingly, the sensor 700 may be vertically aligned with the position of the rod 210 such that the sensor 700 is able to detect a presence of an object within the same unwelded subsection through which the rod 210 will be pushed thereafter. For example, after the vertical clamp 208 moves downward to press on one of the unwelded subsections, such as unwelded subsection 113b (shown in FIG. 4) of the foil packaging 120, the sensor 700 may be configured to determine whether a component is present within the unwelded subsection 113b. Once the sensor 700 identifies a component, such as component 110c (shown in FIG. 4) present in the unwelded subsection 113b, the sensor 700 may transmit the information to the controller, and, based on the transmitted information, the controller may be configured to control the second set of motors 216 to move the rod 210 in the z-axis direction. Accordingly, the second set of motors 216 may be configured to push the rod 210 through the unwelded subsection 113b to remove the respective component 110c packaged therein. If the sensor 700 does not detect any component within the unwelded subsection 113b, the sensor 700 may be configured to transmit the information to the controller, and the controller may temporarily pause the second set of motors 216 such that the rod 210 does not move. In other embodiments, when the sensor 700 does not detect any component within the unwelded subsection 113b, the controller may temporarily pause or shut down the system 200.

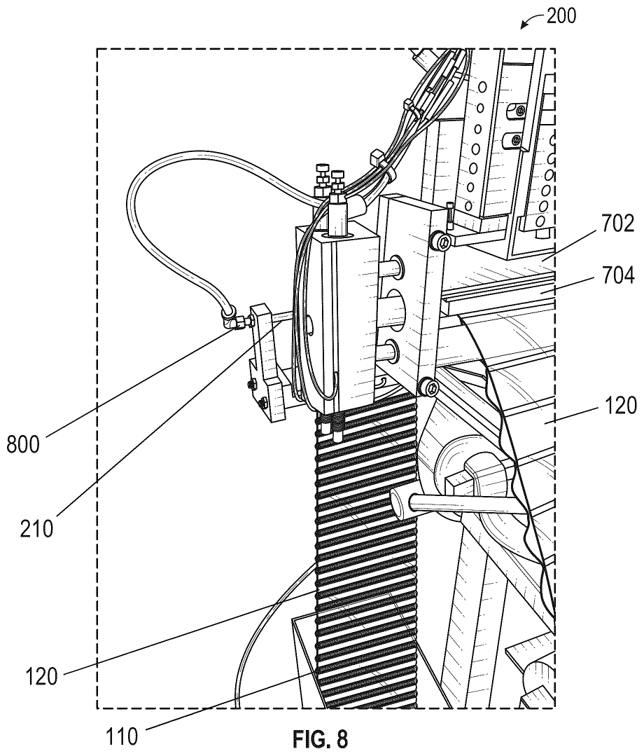

In some embodiments, as shown in FIG. 8, the rod 210 may have a first end and a second end, and an air pressure valve 800 may be coupled to the first end of the rod 210. The air pressure valve 800 may be coupled to an air supply unit, such as an air pump, and the air supply unit may be operably coupled to the controller. In some embodiments, the air supply unit may be in wired or wireless communication with the controller. When the controller controls the second set of motors 216 to move the rod 210 through the unwelded subsection 113b to remove the component 110c therein, the controller may be configured to simultaneously or substantially simultaneously control the air supply unit to blow air through the air pressure valve 800 to the rod 210. Accordingly, the air pressure valve 800 may be configured to selectively blow air into the unwelded subsection 113b while the rod 210 is pushed through the unwelded subsection 113b to facilitate removal of the component 110c therein. In some embodiments, the air pressure valve 800 may be configured to blow continuous air into the unwelded subsection 113b while the rod 210 is being pushed through the unwelded subsection 113b. In other embodiments, the air pressure valve 800 may be configured to blow repeated bursts of air into the unwelded subsection 113b while the rod 210 is being pushed through the unwelded subsection 113b.

After completely pushing the rod 210 through the unwelded subsection 113b, the second set of motors 216 may be configured to retract the rod 210 from the unwelded subsection 113b. FIG. 6A illustrates the system 200 when the rod 210 is retracted from the unwelded subsection(s) of the foil packaging 120, and FIG. 6B illustrates the system 200 when the rod 210 is pushed through the unwelded subsection(s) of the foil packaging 120 to remove the component(s) packaged therein.

In some embodiments, the system 200 may also comprise a bar 704, as shown in FIGS. 7 and 8, disposed on the back side of the axle 702. In some embodiments, the bar 704 may be made from rubber or any other material that is capable of providing friction when in contact with the foil packaging 120. The bar 704 may be configured to facilitate removal of the component(s) disposed within the foil packaging 120. For example, when the vertical clamp 208 is moved downward to press on one of the unwelded subsections, such as unwelded subsection 113b, of the foil packaging 120, the bar 704 may come into contact with a portion of the foil packaging 120. Afterwards, the controller may be configured to move the bar 704 towards the rod 210 such that the bar 704 pushes the foil packaging 120 towards the rod 210. This, in turn, may widen the cavity within the unwelded subsection 113b such that the rod 210 can easily push through the unwelded subsection 113b to remove the component 110c therein.

After retracting the rod 210 from the unwelded subsection 113b, the first set of motors 214 may be configured to lift the vertical clamp 208 upward and off of the unwelded subsection 113b of the foil packaging 120. Once the vertical clamp 208 is no longer in contact with the foil packaging 120, the controller may be configured to control the third set of motors 215 to rotate the plurality of rollers 206a-c and guide the foil packaging 120 along the unloading assembly 203. By way of example, the third set of motors 215 may be configured to rotate the rollers 206a-c such that the subsequent unwelded subsection 113c (shown in FIG. 4) is aligned with a position of the rod 210 to remove the subsequent component 110d from the foil packaging 120.

In some embodiments, the sensor 700 may also be configured to detect whether the foil packaging 120 is jammed within the system 200. For example, the sensor 700 may be configured to determine whether the foil packaging 120 is moving on the belt 204. If the sensor 700 does not detect any movement of the foil packaging 120, the sensor 700 may determine that the foil packaging 120 is stuck or jammed within the system 200 and transmit the information to the controller. In response, the controller may be configured to temporarily pause all motors and rollers of the system 200. In other embodiments, the controller may be configured to temporarily pause or shut down the system 200 when the sensor 700 determines that the foil packaging 120 is stuck in the system 200.

These steps of pushing the vertical clamp 208 onto an unwelded subsection, detecting the presence of a component within the unwelded subsection, moving the foil packaging towards the rod 210, blowing air through the unwelded subsection, pushing the rod 210 through the unwelded subsection to remove a respective component packaged therein, retracting the rod 210 from the unwelded subsection, lifting the vertical clamp 208, and moving the foil packaging along on the plurality of rollers 206a-c to align the subsequent unwelded subsection with the position of the rod 210 can be repeated until each of the components packaged in the foil packaging 120 is removed or unloaded onto, for example, the container 220.

By automating the process of unloading components for a drug delivery device from foil packaging, the system 200 may be configured to unload up to approximately 120 components, such as compression springs or power springs, per minute from the foil packaging. Accordingly, the system 200 may not only reduce or eliminate the labor costs associated with manually removing each individual component before assembly, but the system 200 may also significantly increase the efficiency of unloading components from their packaging using a fully automated or partially automated system. Moreover, because the components are packaged in foil packaging made of thins sheets of foil instead of, for example, plastic trays, the system 200 can reduce the amount of waste discarded at an assembly location, thereby improving sustainability.

All features described herein, including in the specification, claims, abstract, and drawings, and all the steps in any method or process described herein, may be combined in any combination, except combinations where one or more of the features and/or steps are mutually exclusive.

As will be recognized, the systems and methods according to the present disclosure may have one or more advantages relative to conventional technology, any one or more of which may be present in a particular embodiment in accordance with the features of the present disclosure included in that embodiment. Other advantages not specifically listed herein may also be recognized as well.

The above description describes various devices, assemblies, components, subsystems and methods for use related to a drug delivery device. The devices, assemblies, components, subsystems, methods or drug delivery devices can further comprise or be used with a drug including but not limited to those drugs identified below as well as their generic and biosimilar counterparts. The term drug, as used herein, can be used interchangeably with other similar terms and can be used to refer to any type of medicament or therapeutic material including traditional and non-traditional pharmaceuticals, nutraceuticals, supplements, biologics, biologically active agents and compositions, large molecules, biosimilars, bioequivalents, therapeutic antibodies, polypeptides, proteins, small molecules and generics. Non-therapeutic injectable materials are also encompassed. The drug may be in liquid form, a lyophilized form, or in a reconstituted from lyophilized form. The following example list of drugs should not be considered as all-inclusive or limiting

It should also be clear that the devices, assemblies, components, subsystems, methods or drug delivery devices can further comprise use of a medicament listed below with the caveat that the following list should neither be considered to be all inclusive nor limiting. The medicament will be contained in a reservoir. In some instances, the reservoir is a primary container that is either filled or pre-filled for treatment with the medicament. The primary container can be a cartridge or a pre-filled syringe. The primary container may be a needle assembly comprising a syringe barrel.

In some embodiments, the reservoir of the drug delivery device may be filled with or the device can be used with colony stimulating factors, such as granulocyte colony-stimulating factor (G-CSF). Such G-CSF agents include, but are not limited to, Neulasta® (pegfilgrastim, pegylated filgastrim, pegylated G-CSF, pegylated hu-Met-G-CSF) and Neupogen® (filgrastim, G-CSF, hu-MetG-CSF), UDENYCA® (pegfilgrastim-cbqv), Ziextenzo® (LA-EP2006; pegfilgrastim-bmez), or FULPHILA (pegfilgrastim-bmez).

In various other embodiments, the drug delivery device may contain or be used with various pharmaceutical products, such as an erythropoiesis stimulating agent (ESA), which may be in a liquid or a lyophilized form. An ESA is any molecule that stimulates erythropoiesis. In some embodiments, an ESA is an erythropoiesis stimulating protein. As used herein, “erythropoiesis stimulating protein” means any protein that directly or indirectly causes activation of the erythropoietin receptor, for example, by binding to and causing dimerization of the receptor. Erythropoiesis stimulating proteins include erythropoietin and variants, analogs, or derivatives thereof that bind to and activate erythropoietin receptor; antibodies that bind to erythropoietin receptor and activate the receptor; or peptides that bind to and activate erythropoietin receptor. Erythropoiesis stimulating proteins include, but are not limited to, Epogen® (epoetin alfa), Aranesp® (darbepoetin alfa), Dynepo® (epoetin delta), Mircera® (methyoxy polyethylene glycol-epoetin beta), Hematide®, MRK-2578, INS-22, Retacrit® (epoetin zeta), Neorecormon® (epoetin beta), Silapo® (epoetin zeta), Binocrit® (epoetin alfa), epoetin alfa Hexal, Abseamed® (epoetin alfa), Ratioepo® (epoetin theta), Eporatio® (epoetin theta), Biopoin® (epoetin theta), epoetin alfa, epoetin beta, epoetin zeta, epoetin theta, and epoetin delta, as well as the molecules or variants or analogs thereof. Among particular illustrative proteins are the specific proteins set forth below, including fusions, fragments, analogs, variants or derivatives thereof: OPGL specific antibodies, peptibodies, related proteins, and the like (also referred to as RANKL specific antibodies, peptibodies and the like), including fully humanized and human OPGL specific antibodies, particularly fully humanized monoclonal antibodies; Myostatin binding proteins, peptibodies, related proteins, and the like, including myostatin specific peptibodies; IL-4 receptor specific antibodies, peptibodies, related proteins, and the like, particularly those that inhibit activities mediated by binding of IL-4 and/or IL-13 to the receptor; Interleukin 1-receptor 1 (“IL1-R1”) specific antibodies, peptibodies, related proteins, and the like; Ang2 specific antibodies, peptibodies, related proteins, and the like; NGF specific antibodies, peptibodies, related proteins, and the like; CD22 specific antibodies, peptibodies, related proteins, and the like, particularly human CD22 specific antibodies, such as but not limited to humanized and fully human antibodies, including but not limited to humanized and fully human monoclonal antibodies, particularly including but not limited to human CD22 specific IgG antibodies, such as, a dimer of a human-mouse monoclonal hLL2 gamma-chain disulfide linked to a human-mouse monoclonal hLL2 kappa-chain, for example, the human CD22 specific fully humanized antibody in Epratuzumab, CAS registry number 501423-23-0; IGF-1 receptor specific antibodies, peptibodies, and related proteins, and the like including but not limited to anti-IGF-1R antibodies; B-7 related protein 1 specific antibodies, peptibodies, related proteins and the like (“B7RP-1” and also referring to B7H2, ICOSL, B7h, and CD275), including but not limited to B7RP-specific fully human monoclonal lgG2 antibodies, including but not limited to fully human lgG2 monoclonal antibody that binds an epitope in the first immunoglobulin-like domain of B7RP-1, including but not limited to those that inhibit the interaction of B7RP-1 with its natural receptor, ICOS, on activated T cells; IL-15 specific antibodies, peptibodies, related proteins, and the like, such as, in particular, humanized monoclonal antibodies, including but not limited to HuMax IL-15 antibodies and related proteins, such as, for instance, 145c7; IFN gamma specific antibodies, peptibodies, related proteins and the like, including but not limited to human IFN gamma specific antibodies, and including but not limited to fully human anti-IFN gamma antibodies; TALL-1 specific antibodies, peptibodies, related proteins, and the like, and other TALL specific binding proteins; Parathyroid hormone (“PTH”) specific antibodies, peptibodies, related proteins, and the like; Thrombopoietin receptor (“TPO-R”) specific antibodies, peptibodies, related proteins, and the like; Hepatocyte growth factor (“HGF”) specific antibodies, peptibodies, related proteins, and the like, including those that target the HGF/SF: cMet axis (HGF/SF: c-Met), such as fully human monoclonal antibodies that neutralize hepatocyte growth factor/scatter (HGF/SF); TRAIL-R2 specific antibodies, peptibodies, related proteins and the like; Activin A specific antibodies, peptibodies, proteins, and the like; TGF-beta specific antibodies, peptibodies, related proteins, and the like; Amyloid-beta protein specific antibodies, peptibodies, related proteins, and the like; c-Kit specific antibodies, peptibodies, related proteins, and the like, including but not limited to proteins that bind c-Kit and/or other stem cell factor receptors; OX40L specific antibodies, peptibodies, related proteins, and the like, including but not limited to proteins that bind OX40L and/or other ligands of the OX40 receptor; Activase® (alteplase, tPA); Aranesp® (darbepoetin alfa) Erythropoietin [30-asparagine, 32-threonine, 87-valine, 88-asparagine, 90-threonine], Darbepoetin alfa, novel erythropoiesis stimulating protein (NESP); Epogen® (epoetin alfa, or erythropoietin); GLP-1, Avonex® (interferon beta-1a); Bexxar® (tositumomab, anti-CD22 monoclonal antibody); Betaseron® (interferon-beta); Campath® (alemtuzumab, anti-CD52 monoclonal antibody); Dynepo® (epoetin delta); Velcade® (bortezomib); MLN0002 (anti-α4β7 mAb); MLN1202 (anti-CCR2 chemokine receptor mAb); Enbrel® (etanercept, TNF-receptor/Fc fusion protein, TNF blocker); Eprex® (epoetin alfa); Erbitux® (cetuximab, anti-EGFR/HER1/c-ErbB-1); Genotropin® (somatropin, Human Growth Hormone); Herceptin® (trastuzumab, anti-HER2/neu (erbB2) receptor mAb); Kanjinti™ (trastuzumab-anns) anti-HER2 monoclonal antibody, biosimilar to Herceptin®, or another product containing trastuzumab for the treatment of breast or gastric cancers; Humatrope® (somatropin, Human Growth Hormone); Humira® (adalimumab); Vectibix® (panitumumab), Xgeva® (denosumab), Prolia® (denosumab), Immunoglobulin G2 Human Monoclonal Antibody to RANK Ligand, Enbrel® (etanercept, TNF-receptor/Fc fusion protein, TNF blocker), Nplate® (romiplostim), rilotumumab, ganitumab, conatumumab, brodalumab, insulin in solution; Infergen® (interferon alfacon-1); Natrecor® (nesiritide; recombinant human B-type natriuretic peptide (hBNP); Kineret® (anakinra); Leukine® (sargamostim, rhuGM-CSF); LymphoCide® (epratuzumab, anti-CD22 mAb); Benlysta™ (lymphostat B, belimumab, anti-BlyS mAb); Metalyse® (tenecteplase, t-PA analog); Mircera® (methoxy polyethylene glycol-epoetin beta); Mylotarg® (gemtuzumab ozogamicin); Raptiva® (efalizumab); Cimzia® (certolizumab pegol, CDP 870); Soliris™ (eculizumab); pexelizumab (anti-C5 complement); Numax® (MEDI-524); Lucentis® (ranibizumab); Panorex® (17-1A, edrecolomab); Trabio® (lerdelimumab); TheraCim hR3 (nimotuzumab); Omnitarg (pertuzumab, 2C4); Osidem® (IDM-1); OvaRex® (B43.13); Nuvion® (visilizumab); cantuzumab mertansine (huC242-DM1); NeoRecormon® (epoetin beta); Neumega® (oprelvekin, human interleukin-11); Orthoclone OKT3® (muromonab-CD3, anti-CD3 monoclonal antibody); Procrit® (epoetin alfa); Remicade® (infliximab, anti-TNFα monoclonal antibody); Reopro® (abciximab, anti-GP Ilb/llia receptor monoclonal antibody); Actemra® (anti-IL6 Receptor mAb); Avastin® (bevacizumab), HuMax-CD4 (zanolimumab); Mvasi™ (bevacizumab-awwb); Rituxan® (rituximab, anti-CD20 mAb); Tarceva® (erlotinib); Roferon-A®-(interferon alfa-2a); Simulect® (basiliximab); Prexige® (lumiracoxib); Synagis® (palivizumab); 145c7-CHO (anti-IL15 antibody, see U.S. Pat. No. 7,153,507); Tysabri® (natalizumab, anti-α4integrin mAb); Valortim® (MDX-1303, anti-B. anthracis protective antigen mAb); ABthrax™; Xolair® (omalizumab); ETI211 (anti-MRSA mAb); IL-1 trap (the Fc portion of human lgG1 and the extracellular domains of both IL-1 receptor components (the Type I receptor and receptor accessory protein)); VEGF trap (lg domains of VEGFR1 fused to lgG1 Fc); Zenapax® (daclizumab); Zenapax® (daclizumab, anti-IL-2Ra mAb); Zevalin® (ibritumomab tiuxetan); Zetia® (ezetimibe); Orencia® (atacicept, TACI-lg); anti-CD80 monoclonal antibody (galiximab); anti-CD23 mAb (lumiliximab); BR2-Fc (huBR3/huFc fusion protein, soluble BAFF antagonist); CNTO 148 (golimumab, anti-TNFα mAb); HGS-ETR1 (mapatumumab; human anti-TRAIL Receptor-1 mAb); HuMax-CD20 (ocrelizumab, anti-CD20 human mAb); HuMax-EGFR (zalutumumab); M200 (volociximab, anti-α5β1 integrin mAb); MDX-010 (ipilimumab, anti-CTLA-4 mAb and VEGFR-1 (IMC-18F1); anti-BR3 mAb; anti-C. difficile Toxin A and Toxin B C mAbs MDX-066 (CDA-1) and MDX-1388); anti-CD22 dsFv-PE38 conjugates (CAT-3888 and CAT-8015); anti-CD25 mAb (HuMax-TAC); anti-CD3 mAb (NI-0401); adecatumumab; anti-CD30 mAb (MDX-060); MDX-1333 (anti-IFNAR); anti-CD38 mAb (HuMax CD38); anti-CD40L mAb; anti-Cripto mAb; anti-CTGF Idiopathic Pulmonary Fibrosis Phase I Fibrogen (FG-3019); anti-CTLA4 mAb; anti-eotaxin1 mAb (CAT-213); anti-FGF8 mAb; anti-ganglioside GD2 mAb; anti-ganglioside GM2 mAb; anti-GDF-8 human mAb (MYO-029); anti-GM-CSF Receptor mAb (CAM-3001); anti-HepC mAb (HuMax HepC); anti-IFNα mAb (MEDI-545, MDX-198); anti-IGF1R mAb; anti-IGF-1R mAb (HuMax-Inflam); anti-IL12 mAb (ABT-874); anti-IL12/IL23 mAb (CNTO 1275); anti-IL13 mAb (CAT-354); anti-IL2Ra mAb (HuMax-TAC); anti-IL5 Receptor mAb; anti-integrin receptors mAb (MDX-018, CNTO 95); anti-IP10 Ulcerative Colitis mAb (MDX-1100); BMS-66513; anti-Mannose Receptor/hCGβ mAb (MDX-1307); anti-mesothelin dsFv-PE38 conjugate (CAT-5001); anti-PD1mAb (MDX-1106 (ONO-4538)); anti-PDGFRa antibody (IMC-3G3); anti-TGFβ mAb (GC-1008); anti-TRAIL Receptor-2 human mAb (HGS-ETR2); anti-TWEAK mAb; anti-VEGFR/FIt-1 mAb; and anti-ZP3 mAb (HuMax-ZP3).

In some embodiments, the drug delivery device may contain or be used with a sclerostin antibody, such as but not limited to romosozumab, blosozumab, BPS 804 (Novartis), Evenity™ (romosozumab-aqqg), another product containing romosozumab for treatment of postmenopausal osteoporosis and/or fracture healing and in other embodiments, a monoclonal antibody (lgG) that binds human Proprotein Convertase Subtilisin/Kexin Type 9 (PCSK9). Such PCSK9 specific antibodies include, but are not limited to, Repatha® (evolocumab) and Praluent® (alirocumab). In other embodiments, the drug delivery device may contain or be used with rilotumumab, bixalomer, trebananib, ganitumab, conatumumab, motesanib diphosphate, brodalumab, vidupiprant or panitumumab. In some embodiments, the reservoir of the drug delivery device may be filled with or the device can be used with IMLYGIC® (talimogene laherparepvec) or another oncolytic HSV for the treatment of melanoma or other cancers including but are not limited to OncoVEXGALV/CD; OrienX010; G207, 1716; NV1020; NV12023; NV1034; and NV1042. In some embodiments, the drug delivery device may contain or be used with endogenous tissue inhibitors of metalloproteinases (TIMPs) such as but not limited to TIMP-3. In some embodiments, the drug delivery device may contain or be used with Aimovig® (erenumab-aooe), anti-human CGRP-R (calcitonin gene-related peptide type 1 receptor) or another product containing erenumab for the treatment of migraine headaches. Antagonistic antibodies for human calcitonin gene-related peptide (CGRP) receptor such as but not limited to erenumab and bispecific antibody molecules that target the CGRP receptor and other headache targets may also be delivered with a drug delivery device of the present disclosure. Additionally, bispecific T cell engager (BiTE®) antibodies such as but not limited to BLINCYTO® (blinatumomab) can be used in or with the drug delivery device of the present disclosure. In some embodiments, the drug delivery device may contain or be used with an APJ large molecule agonist such as but not limited to apelin or analogues thereof. In some embodiments, a therapeutically effective amount of an anti-thymic stromal lymphopoietin (TSLP) or TSLP receptor antibody is used in or with the drug delivery device of the present disclosure. In some embodiments, the drug delivery device may contain or be used with Avsola™ (infliximab-axxq), anti-TNF a monoclonal antibody, biosimilar to Remicade® (infliximab) (Janssen Biotech, Inc.) or another product containing infliximab for the treatment of autoimmune diseases. In some embodiments, the drug delivery device may contain or be used with Kyprolis® (carfilzomib), (2S)-N-((S)-1-((S)-4-methyl-1-((R)-2-methyloxiran-2-yl)-1-oxopentan-2-ylcarbamoyl)-2-phenylethyl)-2-((S)-2-(2-morpholinoacetamido)-4-phenylbutanamido)-4-methylpentanamide, or another product containing carfilzomib for the treatment of multiple myeloma. In some embodiments, the drug delivery device may contain or be used with Otezla® (apremilast), N-[2-[(1S)-1-(3-ethoxy-4-methoxyphenyl)-2-(methylsulfonyl)ethyl]-2,3-dihydro-1,3-dioxo-1H-isoindol-4-yllacetamide, or another product containing apremilast for the treatment of various inflammatory diseases. In some embodiments, the drug delivery device may contain or be used with Parsabiv™ (etelcalcetide HCl, KAI-4169) or another product containing etelcalcetide HCl for the treatment of secondary hyperparathyroidism (sHPT) such as in patients with chronic kidney disease (KD) on hemodialysis. In some embodiments, the drug delivery device may contain or be used with ABP 798 (rituximab), a biosimilar candidate to Rituxan®/MabThera™, or another product containing an anti-CD20 monoclonal antibody. In some embodiments, the drug delivery device may contain or be used with a VEGF antagonist such as a non-antibody VEGF antagonist and/or a VEGF-Trap such as aflibercept (Ig domain 2 from VEGFR1 and Ig domain 3 from VEGFR2, fused to Fc domain of lgG1). In some embodiments, the drug delivery device may contain or be used with ABP 959 (eculizumab), a biosimilar candidate to Soliris®, or another product containing a monoclonal antibody that specifically binds to the complement protein C5. In some embodiments, the drug delivery device may contain or be used with Rozibafusp alfa (formerly AMG 570) is a novel bispecific antibody-peptide conjugate that simultaneously blocks ICOSL and BAFF activity. In some embodiments, the drug delivery device may contain or be used with Omecamtiv mecarbil, a small molecule selective cardiac myosin activator, or myotrope, which directly targets the contractile mechanisms of the heart, or another product containing a small molecule selective cardiac myosin activator. In some embodiments, the drug delivery device may contain or be used with Sotorasib (formerly known as AMG 510), a KRASG12C small molecule inhibitor, or another product containing a KRASG12C small molecule inhibitor. In some embodiments, the drug delivery device may contain or be used with Tezepelumab, a human monoclonal antibody that inhibits the action of thymic stromal lymphopoietin (TSLP), or another product containing a human monoclonal antibody that inhibits the action of TSLP. In some embodiments, the drug delivery device may contain or be used with rocatinlimab (AMG 451), a human anti-OX40 monoclonal antibody that is expressed on activated T cells and blocks OX40 to inhibit and/or reduce the number of OX40 pathogenic T cells that are responsible for driving system and local atopic dermatitis inflammatory responses. In some embodiments, the drug delivery device may contain or be used with AMG 714, a human monoclonal antibody that binds to Interleukin-15 (IL-15) or another product containing a human monoclonal antibody that binds to Interleukin-15 (IL-15). In some embodiments, the drug delivery device may contain or be used with AMG 890, a small interfering RNA (siRNA) that lowers lipoprotein (a), also known as Lp (a), or another product containing a small interfering RNA (siRNA) that lowers lipoprotein (a). In some embodiments, the drug delivery device may contain or be used with ABP 654 (human lgG1 kappa antibody), a biosimilar candidate to Stelara®, or another product that contains human lgG1 kappa antibody and/or binds to the p40 subunit of human cytokines interleukin (IL)-12 and IL-23. In some embodiments, the drug delivery device may contain or be used with Amjevita™ or Amgevita™ (formerly ABP 501) (mab anti-TNF human lgG1), a biosimilar candidate to Humira®, or another product that contains human mab anti-TNF human lgG1. In some embodiments, the drug delivery device may contain or be used with AMG 160, or another product that contains a half-life extended (HLE) anti-prostate-specific membrane antigen (PSMA) x anti-CD3 BiTE® (bispecific T cell engager) construct. In some embodiments, the drug delivery device may contain or be used with AMG 119, or another product containing a delta-like ligand 3 (DLL3) CAR T (chimeric antigen receptor T cell) cellular therapy. In some embodiments, the drug delivery device may contain or be used with AMG 119, or another product containing a delta-like ligand 3 (DLL3) CAR T (chimeric antigen receptor T cell) cellular therapy. In some embodiments, the drug delivery device may contain or be used with AMG 133, or another product containing a gastric inhibitory polypeptide receptor (GIPR) antagonist and GLP-1R agonist. In some embodiments, the drug delivery device may contain or be used with AMG 171 or another product containing a Growth Differential Factor 15 (GDF15) analog. In some embodiments, the drug delivery device may contain or be used with AMG 176 or another product containing a small molecule inhibitor of myeloid cell leukemia 1 (MCL-1). In some embodiments, the drug delivery device may contain or be used with AMG 199 or another product containing a half-life extended (HLE) bispecific T cell engager construct (BiTE®). In some embodiments, the drug delivery device may contain or be used with AMG 256 or another product containing an anti-PD-1X IL21 mutein and/or an IL-21 receptor agonist designed to selectively turn on the Interleukin 21 (IL-21) pathway in programmed cell death-1 (PD-1) positive cells. In some embodiments, the drug delivery device may contain or be used with AMG 330 or another product containing an anti-CD33X anti-CD3 BiTE® (bispecific T cell engager) construct. In some embodiments, the drug delivery device may contain or be used with AMG 404 or another product containing a human anti-programmed cell death-1 (PD-1) monoclonal antibody being investigated as a treatment for patients with solid tumors. In some embodiments, the drug delivery device may contain or be used with AMG 427 or another product containing a half-life extended (HLE) anti-fms-like tyrosine kinase 3 (FLT3) x anti-CD3 BITE® (bispecific T cell engager) construct. In some embodiments, the drug delivery device may contain or be used with AMG 430 or another product containing an anti-Jagged-1 monoclonal antibody. In some embodiments, the drug delivery device may contain or be used with AMG 506 or another product containing a multi-specific FAP x 4-1BB-targeting DARPin® biologic under investigation as a treatment for solid tumors. In some embodiments, the drug delivery device may contain or be used with AMG 509 or another product containing a bivalent T-cell engager and is designed using XmAb® 2+1 technology. In some embodiments, the drug delivery device may contain or be used with AMG 562 or another product containing a half-life extended (HLE) CD19X CD3 BiTE® (bispecific T cell engager) construct. In some embodiments, the drug delivery device may contain or be used with Efavaleukin alfa (formerly AMG 592) or another product containing an IL-2 mutein Fc fusion protein. In some embodiments, the drug delivery device may contain or be used with AMG 596 or another product containing a CD3 x epidermal growth factor receptor vill (EGFRvIII) BiTE® (bispecific T cell engager) molecule. In some embodiments, the drug delivery device may contain or be used with AMG 673 or another product containing a half-life extended (HLE) anti-CD33 x anti-CD3 BiTE® (bispecific T cell engager) construct. In some embodiments, the drug delivery device may contain or be used with AMG 701 or another product containing a half-life extended (HLE) anti-B-cell maturation antigen (BCMA) x anti-CD3 BITE® (bispecific T cell engager) construct. In some embodiments, the drug delivery device may contain or be used with AMG 757 or another product containing a half-life extended (HLE) anti-delta-like ligand 3 (DLL3) x anti-CD3 BITE® (bispecific T cell engager) construct. In some embodiments, the drug delivery device may contain or be used with AMG 910 or another product containing a half-life extended (HLE) epithelial cell tight junction protein claudin 18.2 x CD3 BITE® (bispecific T cell engager) construct.

Although the drug delivery devices, assemblies, components, subsystems and methods have been described in terms of exemplary embodiments, they are not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above-described embodiments without departing from the spirit and scope of the invention(s) disclosed herein, and that such modifications, alterations, and combinations are to be viewed as being within the ambit of the inventive concept(s).

1. A method of foil packaging components for a drug delivery device, the method comprising:
introducing a first sheet of foil and a second sheet of foil into a welding assembly, the welding assembly including a first welding bar and a second welding bar;
welding the first sheet of foil and the second sheet of foil together at a first subsection of the first and second sheets of foil to define a first welded subsection, wherein welding the first and second sheets of foil together at the first subsection includes clamping the first welding bar and the second welding bar at the first subsection;
providing a component for a drug delivery device between the first sheet of foil and the second sheet of foil above the first welded subsection;
unclamping the first welding bar and the second welding bar from the first welded subsection;
moving the first sheet of foil and the second sheet of foil downward in the welding assembly; and
welding the first sheet of foil and the second sheet of foil together at a second subsection of the first and second sheets of foil to define a second welded subsection, the second welded subsection being offset a predefined distance from the first welded subsection,
wherein, after welding the first and second sheets of foil together at the first and second subsections, the first welded subsection is on one side of the component and the second welded subsection is on an opposite side of the component such that the component is surrounded by the first and second sheets of foil.

2. The method of claim 1, further comprising repeating the steps of providing the component for the drug delivery device between the first sheet of foil and the second sheet of foil, unclamping the first and second welding bars, moving the first and second sheets of foil downward in the welding assembly, and welding the first and second sheets of foil together until each of the components for the drug delivery device is individually packaged in foil.

3. The method of claim 1, wherein introducing the first sheet of foil and the second sheet of foil into the welding assembly comprises introducing a first roll of foil along a first set of rollers and a second roll of foil along a second set of rollers into the welding assembly.

4. The method of claim 1, wherein the drug delivery device includes an autoinjector, and wherein the component for the drug delivery device includes at least one of a compression spring or a power spring.

5. (canceled)

6. The method of claim 1, wherein the predefined distance between the first subsection and the second subsection is adjustable based on at least a dimension of the component for the drug delivery device.

7. The method of claim 1, wherein moving the first and second sheets of foil downward further comprises:
clamping the first and second sheets of foil between a first jaw and a second jaw of a transporting assembly at the first welded subsection;
moving the first and second jaws of the transporting assembly downward; and
unclamping the first and second jaws.

8. The method of claim 7, wherein the first and second welding bars of the welding assembly are moveable along an x-axis, and wherein the first and second jaws of the transporting assembly are moveable along the x-axis and a y-axis.

9. A method of unloading components for a drug delivery device from foil packaging, the method comprising:
loading a foil packaging onto a belt of an unloading assembly, the foil packaging including a first sheet of foil and a second sheet of foil defining a plurality of alternating welded and unwelded subsections, the components for the drug delivery device being individually packaged in the unwelded subsections using the method of claim 1;
pressing the foil packaging on the belt using a vertical clamp of the unloading assembly;
pushing a rod of the unloading assembly through an unwelded subsection of the plurality of unwelded subsections to remove a respective component of the drug delivery device packaged therein;
retracting the rod from the unwelded subsection;
lifting the vertical clamp from the foil packaging; and
moving the foil packaging on a set of rollers of the unloading assembly such that a subsequent unwelded subsection of the plurality of unwelded subsections is aligned with a position of the rod of the unloading assembly.

10. The method of claim 9, further comprising repeating the steps of pressing the foil packaging on the belt using the vertical clamp, pushing the rod through an unwelded subsection to remove a respective component of the drug delivery device packaged therein, retracting the rod from the unwelded subsection, lifting the vertical clamp, and moving the foil packaging on the set of rollers such that a subsequent unwelded subsection is aligned with the position of the rod until each of the components packaged in the foil packaging is unloaded.

11. The method of claim 9, wherein the rod of the unloading assembly is moveable along a z-axis.

12. The method of claim 9, further comprising, prior to pushing the rod through the unwelded subsection to remove the respective component packaged therein, detecting, using a sensor, a presence of the respective component in the unwelded subsection, wherein the sensor comprises an optical sensor or a magnetic sensor.

13. (canceled)

14. The method of claim 9, further comprising controlling an air pressure valve coupled to the rod to provide air into the unwelded subsection while the rod is pushed through the unwelded subsection to remove the respective component packaged therein.

15. A system for foil packaging components for a drug delivery device, comprising:
a first set of rollers configured to introduce a first sheet of foil;
a second set of rollers configured to introduce a second sheet of foil;
a welding assembly configured to receive the first and second sheets of foil and weld the first and second sheets of foil at a plurality of subsections thereof to define a plurality of welded subsections, the welding assembly including a first welding bar and a second welding bar moveable along an x-axis;
an arm configured to provide a component for a drug delivery device between the first and second sheets of foil in the welding assembly; and
a transporting assembly operably coupled to the welding assembly and including a first jaw and a second jaw moveable along the x-axis and a y-axis, the first and second jaws being configured to clamp the first and second sheets of foil at the welded subsections to move the first and second sheets of foil, thereby positioning a subsequent subsection of the plurality of subsections between the first welding bar and the second welding bar for welding.

16. The system of claim 15, further comprising:
a first set of motors configured to control a movement of the first and second welding bars of the welding assembly;
a second set of motors configured to control a movement of the first and second jaws of the transporting assembly; and
a controller operably coupled to the first set of motors and the second set of motors.

17. The system of claim 16, wherein the controller is configured to control the second set of motors such that the movement of the first and second jaws is synchronized.

18. The system of claim 16, wherein the controller is configured to control the first set of motors such that the movement of the first and second welding bars is synchronized.

19. The system of claim 18, wherein the controller is configured to control the first set of motors such that the plurality of welded subsections are offset from each other by a predefined distance, wherein the predefined distance is adjustable based on at least a dimension of the component for the drug delivery device.

20. (canceled)

21. The system of claim 15, wherein the drug delivery device includes an autoinjector, wherein the component for the drug delivery device includes at least one of a compression spring or a power spring.

22. (canceled)

23. A system for unloading components for a drug delivery device from foil packaging, comprising:
an unloading assembly including a belt configured to support at least a portion of a foil packaging thereon, the foil packaging defining a plurality of alternating welded and unwelded subsections, each of the unwelded subsections being configured to accommodate a component for a drug delivery device therein;
a plurality of rollers configured to receive the foil packaging from the belt and move the foil packaging away from the belt;
a vertical clamp operably coupled to the unloading assembly, the vertical clamp being configured to move along a y-axis to press a section of the foil packaging on the belt; and
a rod moveable along a z-axis and configured to push through the unwelded subsections of the foil packaging to remove a respective component of the drug delivery device packaged therein.

24. The system of claim 23, further comprising:
a first set of motors configured to control a movement of the vertical clamp;
a second set of motors configured to control a movement of the rod;
a third set of motors configured to control a movement of the plurality of rollers; and
a controller operably coupled to the first, second, and third sets of motors.

25. The system of claim 24, wherein the controller is configured to control the first, second, and third sets of motors such that the movement of the vertical clamp, the rod, and the plurality of rollers are synchronized.

26. The system of claim 24, wherein the controller is configured to control the first, second, and third sets of motors such that a position of the rod is aligned with a subsequent unwelded subsections of the plurality of unwelded subsections after removing a respective component from a preceding unwelded subsections of the plurality of unwelded subsections.

27. The system of claim 23, wherein the drug delivery device includes an autoinjector, wherein the component for the drug delivery device includes at least one of a compression spring or a power spring.

28. (canceled)

29. The system of claim 23, further comprising a sensor configured to detect a presence of a component within an unwelded subsection prior to the rod pushing through the unwelded subsection of the foil packaging to remove the component packaged therein, wherein the sensor comprises an optical sensor or a magnetic sensor.

30. (canceled)

31. The system of claim 23, further comprising an air pressure valve operably coupled to the rod, wherein the air pressure valve is configured to selectively provide air into the unwelded subsections while the rod is pushed through the unwelded subsections to remove the respective component packaged therein.
